(19) United States
(12) Patent Application Publication
(10) Pub. No.: US 2026/0211243 A1
(43) Pub. Date: Jul. 23, 2026

(54) MONOCULAR ULTRA-NEAR-TO-EYE WEARABLE DISPLAY APPARATUS FOR AGUMENTED REALITY

(71) Applicant: Amalgamated Vision, LLC, Brentwood, TN (US)

(72) Inventors: Randall SPRAGUE, Hansville, WA (US); Adam J. DAVIS, Brentwood, TN (US); David KESSLER, New York, NY (US); Nestor O. FARMIGA, Rochester, NY (US); Markus BAUER, Rochester, NY (US)

(21) Appl. No.: 19/456,549

(22) Filed: Jan. 22, 2026

Related U.S. Application Data
(60) Provisional application No. 63/747,968, filed on Jan. 22, 2025.
(60) Provisional application No. 63/786,475, filed on Apr. 10, 2025.

(51) Int. Cl. G02B 27/01; G02B 27/00

(52) U.S. Cl. CPC G02B 27/0172; G02B 27/0093; G02B 27/0176; G02B 2027/011; G02B 2027/0116; G02B 2027/0138; G02B 2027/014; G02B 2027/015; G02B 2027/0152; G02B 2027/0161; G02B 2027/0169

(57) ABSTRACT

A wearable display apparatus for a viewer has a display configured to emit image-bearing light and optics configured to collimate the image-bearing light from the display and direct the collimated light along a display axis that extends toward an eye of the viewer. An enclosure is supported by headwear worn by the viewer and is configured to position the display and optics positioned within the peripheral and intermediate visual field, but outside the central or macular visual field of the ipsilateral eye and to direct the display axis toward the eye of the viewer. The normal line of sight of the eye of the viewer, lying outside of the visible field of the contralateral eye, positions the ocular within 16 mm of the cornea of the viewer's eye.

### PRIORITY

The present application claims priority to U.S. Provisional Pat. Appl. No. 63/786,475 filed Apr. 10, 2025, and U.S. Provisional Pat. Appl. No. 63/747,968 filed Jan. 22, 2025, the disclosures of which are hereby incorporated by reference in their entireties.

### BACKGROUND OF THE INVENTION

The present application is directed to head-mounted displays (HMDs) and more particularly to an HMD for augmented reality, producing visual fusion between digital content and the real-world scene, via a display apparatus that is monocular, ultra near to the medial (nasal) aspect of the eye, and with an unobstructed central or macular visual field.

In spite of considerable gains in component miniaturization and skillful optical design, conventional HMD devices remain unsatisfactory for many prospective applications. For many marketed and proposed devices, size and bulk as well as disappointing optical performance present unacceptable limitations. HMDs can be particularly cumbersome and obtrusive in augmented reality (AR) applications, where the HMD is intended to supplement or overlay the real-world field of view with computer-stored or computer-generated content. Existing devices can cause a number of problems for the HMD wearer, including neck pain, eye strain, headaches, disorientation, visual confusion and nausea.

Currently, HMDs are classified by type, either virtual reality (VR) or augmented reality (AR) type. The VR system is immersive, obstructing the real world and showing only digitally generated content. The AR system uses optical “see-through” or electronic “pass-through” methods to overlay digital content over the real-world view. Optical or “see-through” AR systems use combiner elements, typically waveguide lenses, to overlay the digital content onto the visible, real-world scene. Waveguide methods deteriorate the view of the real world by imparting refractive artifacts to the incoming light, resulting in reduced brightness and decreased resolution. The digital overlay is impaired by the waveguide, which reduces contrast and sharpness of the digital image content. Digital content that is continually displayed within the primary field of view can be highly distracting, visually confusing, and increase the overall cognitive burden for the viewer. Even if the digital content is shifted from the straight ahead (primary) direction of gaze, a waveguide continues to be present in front of the eye, and the digital content image quality remains poor due to the incoming light.

Peripheral HMD techniques use an opaque, monocular, or binocular visual display that lies within the peripheral visual field, providing on demand information. Peripheral HMDs are typically opaque, minimizing interference between digital content and real-world content and provide high image quality. However, the device persistently blocks that portion of the visual field over which it is situated. When the gaze is deviated, the device continues to block any environment in its line of sight. Display hardware must be positioned away from the head to allow for user gaze and focus. Bulky support structures are needed for affixing the apparatus to the head. The device is usually situated in the far temporal (lateral) field of view of one eye so as to not encroach on the region of high visual acuity or within the region of binocular vision during normal straight-ahead gaze. The large size of the optomechanical silhouette relative to the smaller size of the display results in poor ergonomics and persistent obscuration within the user's field of view, particularly with non-essential non-display elements.

Thus it can be appreciated that there remains a need for HMD solutions whose size, form factor, and component design significantly alleviate or eliminate the pitfalls of conventional see-through and peripheral HMD systems and are compact, easy to use, provide a high level of image quality, and augment natural vision to allow fusion of digital content with the real-world visible scene in a robust manner that provides ready visibility without visual, physical, physiological, or psychological impairment.

### SUMMARY OF THE INVENTION

An object of the present disclosure is to advance the art of augmented reality viewing using wearable head-mounted displays (HMDs).

Another object of the present disclosure is to address, in whole or in part, at least the foregoing and other deficiencies in the related art. It is a related object of this application to provide, in whole or in part, at least the advantages described herein.

These objects are given only by way of illustrative example, and such objects may be exemplary of one or more embodiments of the application. Other desirable objectives and advantages inherently achieved by the disclosed methods may occur or become apparent to those skilled in the art. The invention is defined by the appended claims.

According to an embodiment of the present disclosure, there is presented a wearable display apparatus for a viewer comprising:
a light source configured to emit image-bearing light;
optics configured to collimate the image-bearing light from the light source and direct the collimated light along a display axis that extends toward a first eye of the viewer; and
an enclosure that is attached and or suspended from headwear worn by the viewer and is configured to position the light source and optics adjacent to a first side of the viewer's nose and to direct the display apparatus axis toward the first eye of the viewer, wherein the path of the display apparatus axis is substantially outside the central field of vision, adjacent to the nose and “nasal blind spot” of the first eye, with any obscuration by the display apparatus situated within the peripheral or intermediate visual field of the first eye, and all of the display apparatus diverted more 30 degrees from the normal line of sight of the first eye of the viewer, lying outside of the visible field of a contralateral second eye of the viewer,
and wherein the enclosure directs the display apparatus axis through an ocular that lies within 16 mm of the cornea of the viewer's first eye (the object focal length of the eye).

According to an embodiment of the present disclosure the display apparatus is larger, allowing for a larger field of view, and may encroach upon the central visual field, but not upon the macular visual field, with all of the display apparatus diverted more than 9 degrees from the normal line of sight of the first eye of the viewer, and with an ocular situated within 16 mm of the cornea of the viewer's first eye (the object focal length of the eye).

According to an embodiment of the present disclosure optics configured to collimate the image-bearing light from the light source and direct the collimated light along a display axis that extends toward a first eye of the viewer utilize internally reflected and polarized light, known as a pancake lens.

According to one aspect of the disclosure, the Applicant provides a wearable display apparatus for a viewer comprising: a micro-display having optics that form an image and are configured to be disposed against the side of the viewer's nose, medial to the eye, within the visual range of a first eye of the viewer and outside the visual range of the contralateral eye, and optionally having a camera or other sensor disposed on the opposite side of the display apparatus, wherein the camera is configured to acquire image content obscured by the display apparatus along a viewer line of sight and wherein the light source is aligned to render the image from the camera and further to overlay digital augmented reality content on the rendered image from the camera or sensor. That digital content may be spatially co-registered to the content of the rendered image from the camera or sensor. When the first eye is not directed toward the optical system, the wearable display apparatus is not visible or is barely noticeable at the edge of the viewer's visual field.

When the display apparatus operates, the viewer can see, from the first eye, the augmented reality digital content, stored or generated, and, according to an embodiment, the camera image from the obscured line of sight, and from the contralateral eye, an unobstructed view of the visual scene. Images can be combined through inherent neurophysiologic behavior that employs a “binocular rivalry” between visual fields of the first and second (contralateral) eyes. The binocular rivalry behavior forms a single cohesive and stable fused image “mosaic” that can be readily comprehended. This may be referred to as “visual fusion.”

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a schematic diagram showing a top view of the binocular visual system.

FIG. 2 shows a front view of visual fields for both eyes.

FIG. 3 shows a front view of visual fields with the display peripheral to right eye vision.

FIG. 4 shows the geometry and measurements of a typical face and the width of the device allowable to not obstruct the macular or central visual field.

FIGS. 5A, 5B and 5C show enclosures surrounding a raster beam scanning embodiment and two flat panel light source embodiments.

FIG. 6 shows a perspective view of the display apparatus as worn by a viewer including the configuration of head band and display apparatus mounting according to an embodiment of the present disclosure.

FIGS. 7A and 7B show position of the display apparatus relative to right-eye (FIG. 7A) and left-eye (FIG. 7B) visual fields.

FIG. 8 shows an example of left and right eye views without augmentation.

FIG. 9 shows an augmented image using an embodiment of the present disclosure.

FIG. 10 shows visual fields with shifted viewer gaze toward the display.

FIG. 11 shows support and positioning features for an embodiment of the head band that supports display alignment.

FIG. 12 shows mechanical components for movement of the enclosure of a flat panel light source embodiment in the Z direction.

FIG. 13 is a perspective view that shows support and positioning features for an embodiment of the head band.

FIG. 14 is a perspective view of one embodiment of the present disclosure that shows support and positioning features for spacing head band components from the nose piece at a selected distance.

FIG. 15 is a perspective view of one embodiment of the present disclosure that shows support and positioning features for spacing head band components from the nose piece at an alternate distance from that shown in FIG. 14.

FIG. 16 shows rotation around the vertical or Y axis (Yaw) of the enclosure for display axis alignment.

FIG. 17 is a perspective view that shows focusing components for the optical enclosure of a raster beam scanning device in an overall view.

FIG. 18 is a perspective view that shows focusing components for the optical enclosure of a raster beam scanning device in an enlarged view.

FIG. 19 shows components for display generation with a camera in schematic form.

FIG. 20 is a perspective view of display apparatus optics with a camera.

FIG. 21 is a schematic view of display apparatus optics with a camera.

FIG. 22 is an example that shows an augmented image that combines ipsilateral eye digital content display and camera/sensor content with the contralateral eye visual field.

FIG. 23 shows an exploded view of components of an augmented image according to an embodiment of the present disclosure.

FIG. 24 is a perspective view of a display apparatus with a camera/sensor without connection to a headpiece or harness.

FIG. 25 is an exploded view showing components of the display apparatus with camera.

FIG. 26 is a schematic diagram of an exemplary eyepiece for a flat panel light source.

FIG. 27 is a perspective view showing eyepiece components for a flat panel light source.

FIG. 28 is a perspective view of optics with the circular exit pupil (eye box) demarcated using an insert for additional diopter accommodation.

FIG. 29 is a perspective view of the optical design with the circular exit pupil (eye box) demarcated of an embodiment using a flat panel light source and pancake lens with length small enough to fit behind the lenses of glasses.

FIG. 30 is a schematic view comparing the size and length of one embodiment using laser beam scanning and a pancake lens versus another embodiment using a flat panel light source and a pancake lens.

### DETAILED DESCRIPTION OF THE INVENTION

The following is a detailed description of exemplary embodiments; reference being made to the drawings in which the same reference numerals identify the same elements of structure in each of the several figures.

Where they are used in the context of the present disclosure, the terms “first”, “second”, and so on, do not necessarily denote any ordinal, sequential, or priority relation, but are simply used to more clearly distinguish one step, element, or set of elements from another, unless specified otherwise.

In the context of the present disclosure, the term “energizable” describes a component or device that is enabled to perform a function upon receiving power and, optionally, upon also receiving an enabling signal.

The term “actuable” has its conventional meaning, relating to a device or component that is capable of effecting an action in response to a stimulus, such as in response to an electrical signal, for example.

The term “minimal” relates to an amount or effect so small as to be insignificant or negligible with respect to a total measurement, amount, or function.

In the context of the present disclosure, the term “coupled” is intended to indicate a mechanical association, connection, relation, or linking, between two or more components, such that the disposition of one component affects the spatial disposition of a component to which it is coupled. For mechanical coupling, two components need not be in direct contact, but can be linked through one or more intermediary components.

The term “set”, as used herein, refers to a non-empty set, as the concept of a collection of elements or members of a set is widely understood in elementary mathematics. The term “subset”, unless otherwise explicitly stated, is used herein to refer to a non-empty proper subset, that is, to a subset of the larger set, having one or more members. For a set Q, a subset may comprise the complete set Q. A “proper subset” of set Q, however, is strictly contained in set Q and excludes at least one member of set Q.

Spatially relative terms, such as “beneath”, “below”, “lower”, “above”, “upper”, and the like, may be used herein for ease of description to describe one element or feature's relationship to another element(s) or feature(s) as described and illustrated in the figures.

The term “exemplary” is used herein to mean “serving as an example, instance, or illustration.” Any aspect described herein as “exemplary” is not necessarily to be construed as preferred or advantageous over other aspects.

In the context of the present disclosure, the term “oblique” describes an angle that would not be considered as either parallel or perpendicular; oblique lines or other structural features differ by least 1 degree from normal or parallel. Two axes, for example, are considered to be oblique with respect to each other if they diverge from or converge toward each other at an angle that is 1 degree or more from parallel, and at least about 1 degree or more from orthogonal. Unless otherwise specified, the term “substantially” means more than half or half-way. Unless otherwise specified, geometric terms, such as “orthogonal” or “normal” are employed as these terms can be interpreted using standard practices and tolerances applied in the imaging arts.

In the context of the present disclosure, the “normal” visible field of the viewer relates to a normal line-of-sight, an axis normal to the eye surface. This normal axis corresponds to the normal line of sight of a viewer who is looking straight ahead. The line of sight is generally considered the central point of viewer gaze (primary point of gaze).

Within the “normal” visible field of the viewer is a region of “high acuity vision.” It may be variably defined as determined by the visual resolution needed for a task to be performed but is usually considered to be that region with the highest concentration of retinal cones and rods. It corresponds to the central visual field, a region of 30-degree radius from the central point of viewer gaze, and/or the macular visual field, a subset of the central visual field, a smaller central region of 9-degree radius. “High acuity vision” is that region defined by perception of the smallest and dimmest stimuli during visual field testing and is that part of the visual field where the most demanding visual tasks are performed.

Overview of the Invention. In imaging optics design, a line of sight is defined by the optical device or system itself. Thus, for example, a telescope or other viewing device defines a line of sight for the viewer, generally the optical axis of the device. Similarly, goggles or eyeglasses define a normal line of sight, based on how the device is used and intended to be worn and based on standard human anatomy for the wearer. Bifocals, for example, define a primary, normal line of sight and may also define one or more secondary, deviated lines of sight for the viewer to use different magnifications. For eyeglasses and other vision optics, the wearer aligns his or her vision line of sight to the line of sight provided by the vision optics design. Lenses and other light-conveying surfaces are accordingly arranged according to conventional anatomy models, wherein the line of sight of the viewer is defined according to alignment of the cornea to a central retina position.

The Applicant's HMD solution provides a wearable display system that is intuitive to use, provides excellent image quality, and is compact and lightweight, comfortable for all-day use in any of a number of applications. The Applicant device works with the visual system of the wearer to help provide augmented image content that can be readily viewed with negligible obstruction of the high acuity normal field of view for the real-world scene. Working with the visual system of the viewer, the Applicant's apparatus provides a unique “fusion-reality” experience that allows the viewer to selectively reallocate a portion of the binocular field of vision for display of digital content as a virtual image. When not visually engaged with the digital content, the viewer enjoys the visual field that lies straight ahead, with negligible perceptible obstruction by the digital display components.

The Applicant has developed a system and approach for image presentation that can provide a viewer with two disparate images composed of simultaneous digital content from one eye and real-world content from the other eye that combine to form a seamless, composite image. This combination of disparate images from the two eyes is often termed a “mosaic.” This capability can superimpose digital content onto the real-world scene to offer AR visual presentation, combining the digital content for one eye, considered the “digital eye” with real world scene from the non-augmented contralateral eye resulting in significant advantages over conventional approaches, having function and appearance not achieved by currently available HMD or related AR systems, as described subsequently herein.

In the description and figures of the present disclosure, the Applicant's monocular solution is shown with a display device providing image content to the viewer's right eye as digital eye. It should be noted that use of the device with the alternate left eye as the digital eye is also possible, with corresponding changes to description as described and illustrated herein. The applicant acknowledges that users may prefer to use this invention as a left sided display device or a right sided display device depending on many factors that may include their personal facial characteristics, visual dominance, brain hemispheric dominance, personal user experience or the particular application the display device is to be used for.

In the description and figures of the present disclosure, the Applicant's monocular solution is shown in an embodiment that employs a micro-display using a flat panel type light source that is energizable to generate an image for the display apparatus. A flat panel light source may include, but is not restricted to, a device using an array having any of a number of emissive component technologies including LED, micro-LED, OLED, micro-OLED, LCD, LCOS, or other emissive technology. The micro-display light source may alternately use other types of light source technologies that are not based on arrays of emissive components or flat panel design, including light beam scanning technology. These include, but would not be limited to, laser beam scanning technologies using micro-laser diodes and a microelectromechanical system (MEMS) energizable to form a laser beam scanning display. Other light beam scanning technologies can be based on LED type light sources. The laser beam scanning and flat panel micro-display device shown in the embodiments herein is used for exemplary purposes and is not intended to be inclusive of all embodiments.

In the description and figures of the present disclosure, an optional embodiment of the Applicant's monocular solution is shown using a front facing camera to capture the obscured field of view for the digital eye, for exemplary purposes as well as for clarity and brevity of description. Any number of alternate types of sensors for detecting energy in the electromagnetic spectrum may be used in the place of a camera. For example, the display device can employ sensors that detect visible light, infrared, ultraviolet, or thermal wavelengths.

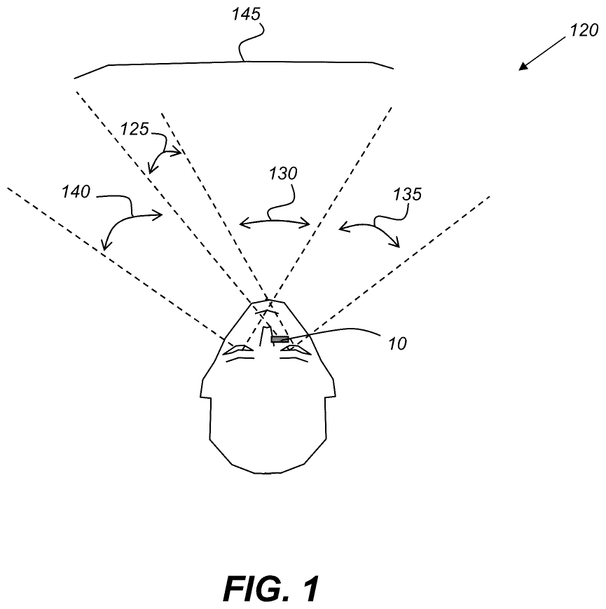

The schematic view of FIG. 1 shows, from a top view, how the viewer's binocular visual field 120 is apportioned relative to the left- and right-eye fields of vision for an individual. The FIG. 1 diagram is illustrative and is not intended to convey exact field of view measurements or proportions. The visual field for each eye has its own range that extends from an outer or lateral extreme (temporal side) to an inner or medial extreme (nasal side). The nasal side for each eye is well-defined, bounded by the nose and nasal bridge.

Both eyes participate to provide binocular vision over a central region, as shown in FIG. 1. The binocular vision range 145 is defined within a region that is common to both left and right eyes, as bounded, respectively for each eye, by the nose and nasal bridge. Outside the binocular vision range, in each respective direction (left and right), lies a visual range that is served only by one corresponding, respective eye, shown as the left eye only region 140 and the right eye only region 145. The limits imposed by the nose and nasal bridge and the region of binocular vision can be readily discerned to the viewer by singly closing each eye.

The Applicant system employs a display apparatus 10 that can be disposed within the object focal length of the eye (<16 mm), termed the “digital” eye, seated adjacent to the nose and nasal bridge, the inner margin of the normal range of binocular vision, and within the nasal (inner or medial) peripheral and intermediate visual field, without reducing the high acuity, most highly usable portion of the visual field, the central visual field or the macular visual field, depending on the embodiment of the invention. This is most readily visualized for the horizontal dimension, as shown in FIG. 1. The Applicant display apparatus 10 can lie against the side of the viewer's nose, along the nasal edge of the visual range for the right eye (in the FIG. 1 example). In examples given herein, with display apparatus 10 impinging on the visual field of the right “digital” eye, the left eye is considered the “unobstructed” or “contralateral” eye. With display apparatus 10 at this position, the viewer still has a full view of the high acuity normal visual field from the right “digital” eye when looking straight ahead; only a portion of the binocular vision range is reduced, shown as region 125 (the range of obstructed binocular vision when using the display apparatus 10). It should be noted that the total visual field of the viewer, covering the full angular range indicated in FIG. 1, is always unobstructed when looking straight ahead as the Applicant's opaque display apparatus 10 does not obstruct the contralateral eye, and obstructs only a portion of the nasal (medial) visual field for the digital eye and thus the entire visual field (shown as the reduced range of binocular vision 130) is seen by at least one eye at all times. Additionally, the high acuity visual field of the digital eye, the most highly usable portion, is not obscured.

With re-allocation of the visual field as shown in FIG. 1, the Applicant HMD display apparatus 10 minimally constrains the overall range of the visual field. That is, there is no loss of the overall visual field range; only a portion of the binocular vision range is effectively re-allocated for display of digital content, as shown.

Binocular Rivalry and Monocular Visual Interference. In re-allocation of the visual field, the Applicant system takes advantage of a characteristic of human vision behavior that can be termed “binocular rivalry” and describes how dissimilar image content from both left and right eyes can be perceived and arranged through eye-brain physiologic and anatomic interaction in the visual mechanism of the viewer. In ordinary vision, similar respective images from each eye combine to provide the binocular portion of the visual field. The slightly shifted perspective of the respective images advantageously enables stereoscopic perception of the visual scene, with corresponding information on depth and perspective. In binocular rivalry, when very dissimilar images are presented, and recognizing that the visual system has limited tolerance for viewing, integrating and comprehending more than one novel image at a time, visual perception naturally alternates with attention between left-eye and right-eye image content. During this process, the dominance relation of either eye is complex and can be dependent upon native brain hemispheric dominance and visual characteristics of the image presented, including motion, brightness, content, and contrast. Altering the image visual characteristics can alter the duration and frequency of ocular dominance for one eye in relation to its contralateral eye. When the image characteristics permit, and the ocular dominance is similar or balanced, the resulting perceptual result can be considered as visual fusion or a “mosaic” of the two dissimilar images.

A broad term for combining generated image content with the real-world scene in the visual field is “vision multiplexing.” Common AR configurations designed to achieve vision multiplexing are binocular and monocular transparent displays, or “see-through” displays. See-through displays can provide a complex and dissonant visual experience, since in addition to binocular rivalry, there is also “visual interference” due to differences between the digital content plane of focus and the real-world plane of focus, as well as conflicting differences in patterns, shapes and boundaries of objects between the digital content and the real-world content either when viewed by a single eye or both eyes.

The monocular opaque display in the Applicant device—a type of peripheral display—avoids visual interference by not showing real world content within the view of the digital eye. This provides a simpler digital image to fuse with the contralateral eye field of view and diminishes the conflict inherent to binocular rivalry, allowing a more stable mosaic composite image and consequently a more robust visio-cognitive comprehension is possible. The science is well described in known literature including Sujin Kima, Shui'Er Hana,b, and Jae-Hyun Junga. Binocular see-through configuration and eye movement attenuate visual rivalry in peripheral wearable displays. Optical Architectures for Displays and Sensing in Augmented, Virtual, and Mixed Reality (AR, VR, MR) IV, edited by Bernard C. Kress, Christophe Peroz, Proc. of SPIE Vol. 12449, 124490T and Laramee, R. and Ware, C. (2002). Rivalry and interference with a head-mounted display. ACM Transactions on Computer-Human Interaction, 9(3), 238. (at internet address http://dx.doi.org/10.1145/568513.568516).

The Applicant provides a display apparatus that is small enough to seat next to the nose, adjacent to the nasal blind spot, within the peripheral visual field and, when thus configured, can be positioned close enough to the eye that it does not obstruct the most usable high acuity normal visual field when the viewer looks directly forward and the display apparatus is not used. The display can be energized when needed (“on demand”) to provide an opaque display with digital content. When not needed, the display can be turned off to avoid distraction to the user from display light scatter.

The characteristics of the image projected by the opaque display to the digital eye can be manipulated to generate digital content that matches or blends seamlessly with the perception of the contralateral eye. This digital content can then be seen superimposed on the real-world view of the contralateral eye in an augmented reality experience, and employing binocular dominance rivalry, to generate a stable “mosaic” that results in a form of “fusion reality.” Conversely, the opaque display image can be rendered more or less conspicuous by altering image characteristics such as brightness, color, contrast, and other characteristics that can tend to increase or decrease the frequency and duration of dominance of the first eye, rendering the digital content more or less pronounced, compared with the contralateral eye real-world view. This type of display device employs a monocular form factor that is small enough to allow its positioning adjacent to the nose and nasal blind spot, only within the nasal (medial) peripheral and intermediate visual field, so that none of it encroaches upon the high acuity central visual field or macular visual field, to provide an on-demand visual augmentation or visual fusion-augmented reality, has been hereto unknown in the art.

Visual Field Nomenclature and Non-Obstruction of the Central and Macular Visual Fields. Visual field testing is a complex diagnostic medical process. The Goldman Visual Field Test is an accepted standard measurement of visual field for an individual. Among documents that explain the fundamental concepts, techniques of measurement, and significance of results is the article entitled “How to Interpret Visual Fields,” Wong SH, Plant GT. Practical Neurology 2015, volume 15, pages 374-381. Briefly, graphical representation of visual fields represents the entire visual hemisphere for a patient, charted relative to a central fixation point, using both 0-360 degrees around the central fixation point and 0-90 degrees from the central fixation point. In this standardized mapping, isopter lines define margins of visual acuity for subject vision at different angles, showing where the subject's visual response perceives given stimuli with the same size and brightness at the respective angles. During a visual field test, stimuli of different size and brightness are presented to the viewing subject in a sequence that helps to map areas of different visual acuity.

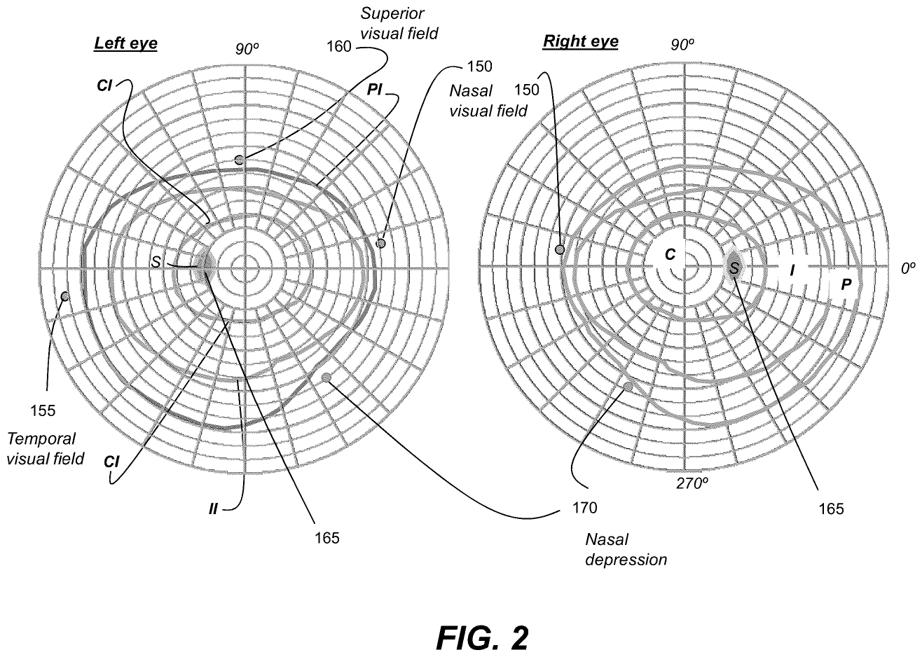

FIG. 2 shows how the left and right visual fields are mapped in conventional polar coordinate space. The left and right visual fields overlap, but are mapped separately in a vision examination, with broad regions as labeled and using isopters to bound regions of particular interest for the positioning of display apparatus 10. Considered horizontally, each eye has a medial or nasal visual field 150 and a lateral or temporal visual field 155. Vertical fields 160 are the superior and inferior, as indicated. Each eye has a corresponding optic disc blind spot 165 noted as “S”. The nasal depression 170 represents the visible field adjacent the bridge of the nose, along the nasal edge.

For a typical adult, the extent of vision, for each eye, is commonly considered to have a horizontal span of approximately 150 degrees and a vertical span of approximately 130 degrees. Relative to the point of central fixation, this range corresponds to 60 degrees medially (nasally), 90 degrees laterally (temporally), 60 degrees superiorly, and 70 degrees inferiorly.

The region of “high acuity vision” may be variably defined as determined by the visual resolution needed for a task to be performed but is usually considered to be the area of highest concentration of retinal cones and rods. This corresponds to the central visual field which includes the smaller macular visual field. The central visual field is that region defined by perception of the smallest and dimmest stimuli during visual field testing and roughly corresponds to the central 60 degrees of vision (a 30 degrees radius from the central fixation point). Physiologically, this is the area served by the highest density of rods and cones at the viewer's retina, is primarily responsible for detailed vision and is where visual attention and comprehension occur allowing for tasks such as spatial understanding of the surrounding environment and object awareness. Within this central visual field there is a region of higher visual acuity, the macular visual field, commonly defined as the central 18 degrees of vision (a 9-degree radius around the central fixation point). The macular visual field is defined by that vision served by the macula, an area of about 3 mm on the retina, which contains the fovea, and the highest concentration of cones at the viewer's retina. The macular vision subserves the highest vision acuity, and is used for detailed comprehension, focused activity and is where vivid color perception occurs. The macular region subserves tasks such as reading, facial recognition, color discrimination, fine manual manipulation and perception of surface detail including texture.

The peripheral visual field is that region defined by perception of only the largest and brightest stimuli and corresponds to regions of low visual acuity served by a low density of rods only. It is more concerned with change of stimuli or movement of objects in the periphery. A mid or intermediate visual field, defined by perception of intermediate size and intensity stimuli, lies between the central and peripheral fields.

Visual regions for an individual are typically mapped as shown in FIG. 2, with spatial regions defined as shown. Central, intermediate, and peripheral regions are bounded between corresponding isopters, lines indicating equal retinal sensitivity. Using the conventional Goldmann visual field mapping familiar to those skilled in vision assessment, each eye of a viewer, that is, each right eye and left eye, has a central visual field C that lies within a central isopter CI and indicates the region of highest retinal sensitivity, roughly centered about an optical axis, a line of vision originating at the retina, wherein the line of sight is modeled as directed straight ahead of the viewer. Surrounding and adjacent to the central visual field C is an intermediate visual field I, bounded by an intermediate isopter (II) and having lower sensitivity relative to the central visual field C. A peripheral visual field (P) lies outside of the intermediate isopter II, bounded along its outer edges by a peripheral isopter (PI). The peripheral isopter defines the limit of the viewer's total visual field for the corresponding eye. Only content that appears within the bounds of the PI is considered to be within the visual field for the corresponding eye. An object or portion of an object that lies outside the PI is not within the visual field for the corresponding eye.

Normal vision can vary significantly from one individual to the next. It should be noted that the visual field mapping given in FIG. 2 is based on statistical averages for a typical adult population. Visual field mapping for the bulk of the viewer population is generally close to the approximation illustrated in FIG. 2. It is also noted that the usability of the visual field, particularly the central and smaller macular visual field, also varies from one individual to the next.

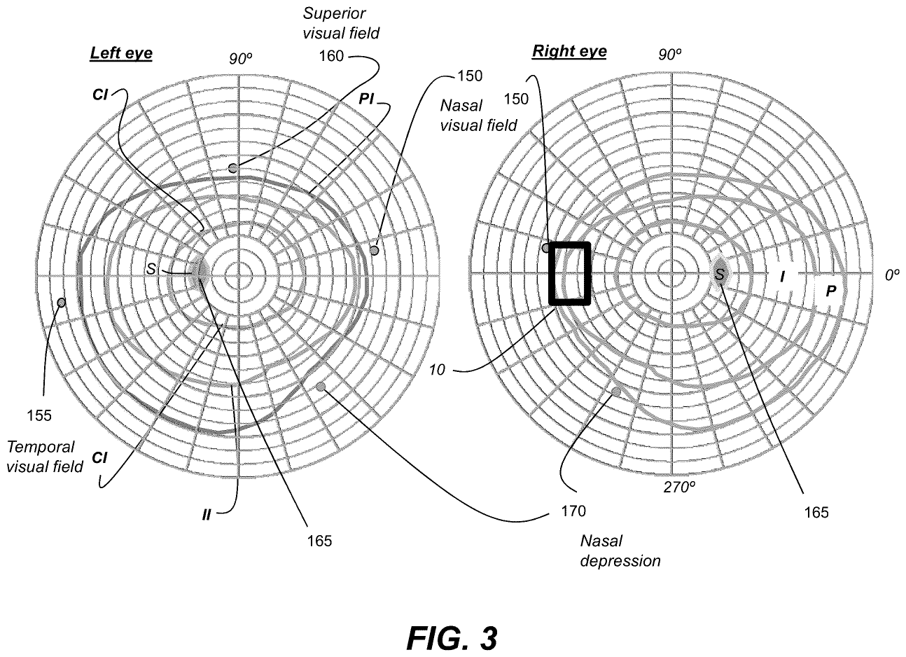

According to an embodiment of the present disclosure, display apparatus 10 positioning is indicated for the right eye in FIG. 3. When display apparatus 10 is suitably adjusted into proper position, the outline of display apparatus 10 of the Applicant effectively utilizes an inner position of the nasal visual field 150 for the left or right eye, adjacent to the nose and within the nasal visual field 150, extending to the PI and II, with the outline well within the region of visual field overlap that is otherwise used for binocular vision as described previously. According to an embodiment of the present disclosure, display apparatus 10 is positioned so that its outline appears to be outside and within the peripheral and intermediate visual field of the viewer, with the 2D area of the display apparatus 10 outline extending within the bounds of the PI and II, and some portion of the 2D area of display apparatus 10 outside the bounded visual field, outside the PI, adjacent to the nose as shown in FIG. 3 during forward gaze. Depending on individual variation there will be variable incursion of the 2D display area upon the peripheral and intermediate visual field during forward gaze. In no case is there incursion upon the macular visual field or with some smaller embodiments, the central visual field, with forward gaze when the display is properly positioned so that for the typical person the encroachment of the display apparatus is always greater than 9 or 30 degrees from the midline of the straight-ahead gaze line of sight.

The size of the field of view occupied by the display in the example of FIG. 3 is approximately 24 degrees vertical and 13.5 degrees horizontal. Please note the display representation is only approximate as it is drawn within a 2-dimensional rendering of a 3-dimensional field and furthermore will vary with any given individual visual field characteristics and facial features. Depending on the size and positioning of the display device and the individual anatomy of the user, obscuration by the 2D area of the display may extend upon the visual field during straight ahead, forward gaze, but may be adjusted so that it does not encroach upon the central visual field or the macular visual field (>30 degree radius and >9 degree radius respectively from the central fixation of gaze) for the typical user, thus minimizing or eliminating obscuration of the region representing high acuity vision.

The Applicants observe that visual acuity degrades significantly beyond the central visual field. The fovea occupies only the central 4-6 degrees of the central visual field but represents >50% of the visual cortex with respect to visual representation in the brain. The slightly larger macular region occupies the central 18 degrees and corresponds to all high visual acuity tasks and the great majority of visual attention. The central visual field occupies the central 60 degrees and serves nearly the remainder of functional vision and environmental/object awareness. For this reason, there can be only minimal impact caused by display apparatus 10 when positioned within the intermediate and/or peripheral visual field. It should be noted that use of display apparatus 10 is not limited to positioning within the peripheral and intermediate visual field. Embodiments with larger displays that provide a greater field of view may have greater encroachment on the central visual field but in no cases encroach upon the macular visual field. The choice of display apparatus embodiment and corresponding visual field encroachment will depend on the size and position of the display and the size of the display image field of view required for any individual user's task and visual content requirements.

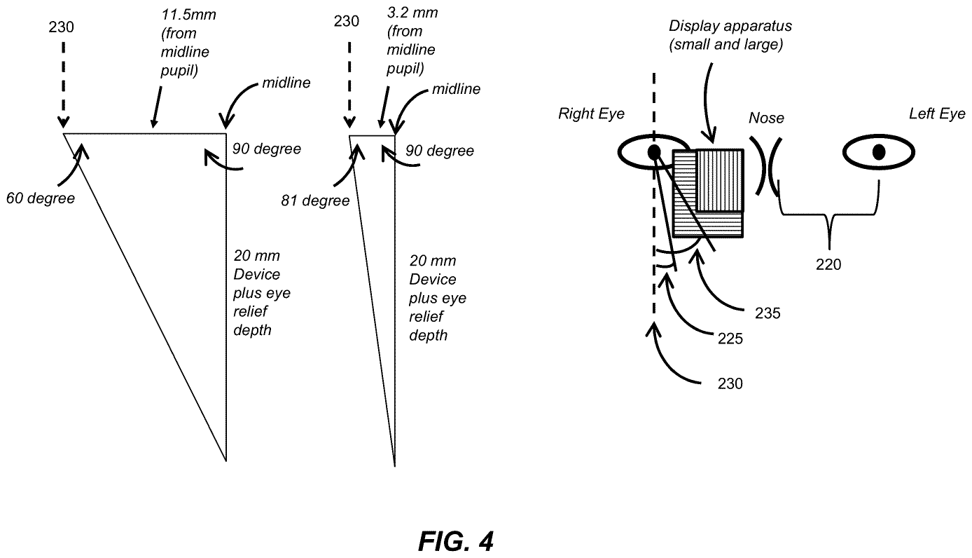

Display Apparatus Width, 2-Dimensional Cross Sectional Area and Visual Field Obstruction. Both the position of the display apparatus, and the dimensions of the height, width and depth of the display apparatus are directly related to how much of the visual field is obscured. This varies by the size and configuration of any individual face but known references for standardized measurements exist including Anthropometry of the Head and Face (2^{nd} Edition) Leslie G. Farkas, MD, (1994) Raven Press NY. In order to simplify, standardize and generalize the features of this invention for descriptive purposes, these known references will be used. For a typical Caucasian North American male, the cross-sectional diameter that does not intrude on the macular visual field or the central visual field can be approximated and depicted in FIG. 4. Given the next to nose position 205 of the display apparatus and the restriction by the physical boundaries of the nose, the width 220, measured from the border of the nose to the center of the pupil, is approximately 23.6 mm. Given a typical embodiment eye relief of 10 mm and a device depth of 10 mm, and a first angle 225 drawn from the center of the pupil with a value of either 9 degrees from the pupillary midline 230 (representing the medial margin of the macular visual field) or a second angle 235 that is 30 degrees from the pupillary midline 230 (representing the medial margin of the central visual field) a device with the medial surface against the nose would need to have a width equal to or less than 20.4 mm to avoid encroaching on the macular visual field. This is approximately 3.2 mm from the mid pupillary line 230. To avoid encroaching on the central visual field the device would need to have a width equal to or less than 12.1 mm. This is approximately 11.5 mm from the mid pupillary line 230. With continued reference to FIG. 4, the geometry and measurements for this typical anthropomorphic example are shown. The first icon 210 with horizontal lines represents a display apparatus 10 that does not block the macular visual field. The second icon 215 with vertical lines represents a display apparatus 10 that does not block the central visual field. It is important to note that this example is for illustrative purposes only, as facial features vary greatly among individuals. Actual measurements for different embodiments of the invention are given in the description below.

The height of the display apparatus 10 is determined in part by the size of the display field of view desired but there are two relevant anthropomorphic landmarks to consider, the typical height of the eye fissure (10.8 mm) and the typical height of the orbit (29.5 mm). Less than the height of the eye fissure would leave available visual field unused, while greater than the orbital height would waste image display on unseen areas. Cross sectional area is then defined by the width of the device multiplied by either the eye fissure height (10.8 mm) or the orbital height (29.5 mm). Consequently, the range of cross-sectional area allowed with a chosen width preventing encroachment upon the central visual field (12.1 mm) as described in the exemplary values above is a value between 130.7 mm*2 to 356.6 mm*2. If a width is selected to avoid encroachment on the macular visual field (20.4 mm) the cross-sectional area would be a range between 220.3 mm*2 to 601.8 mm*2 using the exemplary values above.

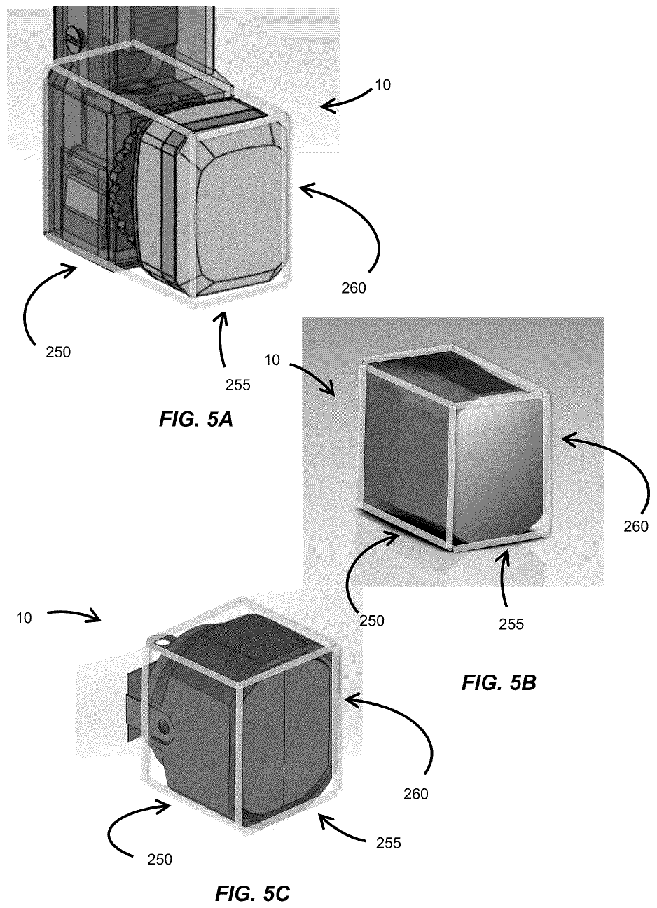

An embodiment of this invention is shown in FIG. 5A using a laser beam scanning light source producing a 27-diagonal field of view, the cross section of the display apparatus 10 is 13 mm width 205 by 14.4 mm height 260 or 187.2 mm*2. This embodiment will likely encroach upon the central visual field for the typical face, even if the device depth 260 is only 10 mm (plus the 10 mm eye relief) but will not encroach upon the macular visual field. For another embodiment shown in FIG. 5B, with the same device field of view using a flat panel (micro-OLED) light source, the cross-sectional area of the display apparatus 10 is 10 mm width 205 by 12 mm height 260 or 120 mm*3. This embodiment will likely not encroach upon the central visual field in the average individual if the device depth 250 is 10 mm plus the 10 mm eye relief. Of note, although both embodiments of FIG. 5A and FIG. 5B are different in size due to difference in optical design, both provide the same 13.5 by 24-degree field of view but given their different widths, each has a different degree of encroachment upon the user's visual field. A third embodiment, shown in FIG. 5C with a flat panel light source and a smaller 20-degree diagonal field of view, has a width 255 of 9.5 mm and a height 206 of 11 mm, resulting in a cross-section of the display apparatus 10 of 104.5 mm*2. If this device is 10 mm or less in depth 250 plus a 10 mm eye relief, the very narrow width of this third embodiment further decreases any possibility of encroachment on the central visual field as well as decreasing any encroachment on the intermediate and/or peripheral visual field.

All embodiments of this invention regardless of light source or field of view are within or less than the range of values for these exemplary cross-sectional areas and device widths so as to not encroach upon the most usable, high acuity visual field (the central or macular visual field) in a typical person. It is important to note again that for any given person, device encroachment on the visual field will be impacted by a given individual's facial features, but except for the most extreme facial variations, the shown embodiments of this invention do not obstruct the macular visual field, and for the smaller display apparatus embodiments shown, do not obstruct the central visual field.

Display Apparatus Volume. The Applicant has found that having the display as close as possible to the eye helps to solve the combined requirements of both: (a) a medial to eye, next-to-nose position, with non-obstruction of the normal forward gaze field of view; with (b) a display field of view large enough to provide an adequate amount of visual content. According to the embodiments of the present disclosure, the optical surface of the display apparatus is within the object focal length of the eye (<16 mm). Typical embodiments of this device have an eye relief of 10 to 12 mm as shown in the previous examples above. To accomplish this, not only must the optics achieve focus of the image on the retina with the device situated extremely close to the cornea, but the optics, light source and enclosure themselves must be extremely small and compact to fit into the very small amount of available anatomic space. In other words, an important consideration of this invention is that the form factor of the display apparatus is constrained by the anatomy of the orbit and face.

The display apparatus volume needs to be less than the volume of the region comprised by the space that is next to the nose and completely outside the visual field-corresponding to the “nasal blind spot”—as well as the space next to the nose that when occupied does not cause obscuration beyond the peripheral and intermediate visual field. This is defined as either outside the central visual field or >30 degrees from the straight-ahead gaze midline of the eye or outside the macular visual field or >9 degrees from the straight-ahead gaze midline of the eye. It is that region that a device can sit within and not cause significant obscuration of the normal usable high acuity field of view. It is approximately defined by the distance from the edge of the nose to the most medial aspect of the eye fissure (the location of the endocanthus), the depth of the nasal root and an angle created by a line drawn from the pupil defining the medial margin of the peripheral visual field. For simplicity this angle must be greater than 30 degrees or 9 degrees from the pupillary midline, which defines the outer margin of the central visual field or macular visual field respectively. For reasons described earlier, the height of this region is no smaller than the height of the eye fissure and no larger than the height of the orbit as defined by the supraorbital and infraorbital rims. Additionally, the display apparatus cannot obstruct the visual field of the contralateral eye.

The actual volume will vary by each individual's facial measurements. Known references for standardized measurements exist including, for example, the previously cited Farkas reference. For a typical young North American Caucasian male adult, the volume of the space within the nasal blind spot, outside the ipsilateral central visual field (>30 degrees from straight ahead gaze midline of the eye), and not blocking the visual field of the contralateral eye, given a height equal to the typical eye fissure and an eye relief of 10 mm so as to not contact the surfaces of the eye and orbit is approximately 3.08 cm*3. If the larger orbital height is used than the volume of the space is larger, 8.42 cm*3. These may be considered minimal and maximal allowable reference volumes for a near to eye display apparatus at the medial aspect of the eye, next to the nose, with an eye relief of 10 mm, that does not obstruct the central visual field on forward gaze. Because the macular visual field has a smaller angle, the allowable reference volume is larger but is less desirable due to greater bulk and worse aesthetics.

In order for the display apparatus to sit behind a pair of spectacle lenses, or other type of lens that corrects vision or protects the eyes, the display apparatus can extend no further out from the eye surface than 25 mm, which is the typical distance of spectacle lenses from the face. Consequently, the volume of the display apparatus would be smaller, approximately 2.44 cm*3 if it is the same height as that of the eye fissure. The previous discussion with regard to FIG. 5A, the embodiment of this invention with a laser beam scanning light source display apparatus 10 with a 24×13.5 degree field of view, does not take into account the presence of lenses of a pair of spectacles. The size of the optomechanical enclosure positioned within this region is 4.86 cm*3, comfortably falling within the range of volume that does not obstruct the normal vision but cannot fit behind the lenses of spectacles. In contradistinction, to fit behind the lenses of spectacles (normally situated 25 mm from the face) given an eye relief of 10 mm (the distance from the surface of the optics of the display apparatus to the surface of the eye) the display apparatus 10 cannot be more than 15 mm in depth 250 (the z axis). Again, with reference to FIG. 5B discussed above, the embodiment disclosed therein corresponds to a flat panel light source with a 24×13.5 degree field of view, which takes into account the presence of lenses of a pair of spectacles, and consists of a display apparatus 10 that is 10 mm in width 255, 12 mm in height 260 and 15 mm in depth 250, constituting a volume of 1.80 cm*3, which is less than the 2.44 cm*3 space defined earlier as the maximum allowable volume for a display apparatus 10 to fit behind a pair of spectacles. With reference to the embodiment shown in FIG. 5C, discussed above, a flat panel light source with a field of view of approximately 15×13 degrees in a display apparatus 10 that is 9.5 mm in width 255, 11 mm in height 260 and 9.5 mm in depth 250, constituting a volume of 0.99 cm*3, which is even smaller than the minimal defined volume. This smaller display apparatus will easily fit behind a pair of spectacles in an inconspicuous manner.

Particularly important is the size ratio of the enclosure and non-image forming opto-mechanics to the viewable elements of the display. The ratio must be small in order to eliminate any non-essential (non-viewable) obstructive silhouette that can diminish the usefulness of the device. Obstruction of this type is a problem with other opaque, see-through and pass-through AR designs and technologies, wherein the opto-mechanics and supporting electromechanical structures contribute significant obstruction of the normal straight ahead visual field. According to an embodiment of this invention, non-image forming elements, for example the enclosure of the display apparatus, add no more than 10% of the total visual area obstructed, as compared with the image forming optics.

To this end, the optical design for both the flat panel and raster scanning light source embodiments is intended to accomplish the above requirements. Previously, an optical design that meets this express goal has not been described in prior art or within augmented reality research literature known to the Applicant. That is: a monocular device, positioned next to nose and ultra near to the eye (within the object focal length of the eye or <16 mm), able to render image content for focus on the retina, with a very small device size and silhouette, that does not obstruct the central or macular visual field on forward gaze when the display apparatus is not in use and then when in use, provides only minimal additional obstruction due to the enclosure and other non-imaging forming elements, that is small enough to sit within the allowable spatial volume given typical facial geometry and in some embodiments additionally able to sit behind the lenses of a pair of spectacles or other corrective/protective lenses. The Applicant's combination of elements in the arrangement described, enables an AR device to provide a user experience described herein, capitalizing on inherent neurophysiological visual elements—a binocular rivalry-derived, visual fusion, “mosaic” image creation.

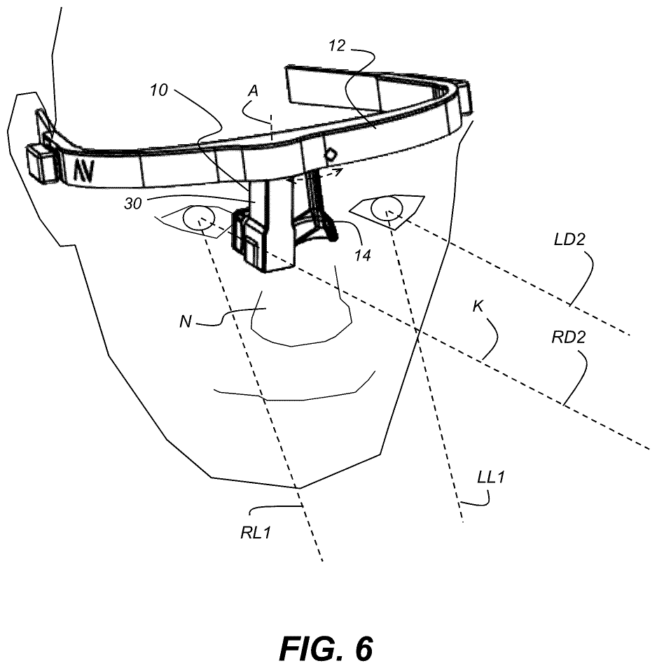

Lines Of Sight and Superimposition of Digital Content and Real-World Content. The display axis, normal to the actual or virtual surface of the display, lies along an optical path that lies outside a periphery of a normal, straight-ahead visual field of the first eye, so that, for example, relative to line of sight RL1 in FIG. 6, the display axis defines an alternate line of sight that is directed at least 30 degrees or 9 degrees away from the straight-ahead, normal line of sight of the first eye at central fixation, shown at RL1. Image-bearing light is considered to be centered about the display axis.

Head band 12 is one alternative mechanism for an adjustable mounting of display apparatus 10 so that it can be suitably shifted, rotated, tilted, and otherwise positioned to present AR image content in a visually unobtrusive arrangement. Eyeglasses or other head-worn apparatus, including helmets, caps, and other headgear worn by the viewer can alternately be used for mounting enclosure 30 of display apparatus 10. Whatever mounting method is used, display apparatus 10, when properly seated just outside the very edge of the central or macular visual field of the right eye of the viewer, is not visible as part of the high-acuity ipsilateral right eye visible field on forward gaze, and is not visible as part of, or within, the contralateral left-eye visible field. Conversely, positioning of display apparatus 10 for the left eye provides the same behavior, for opposite eyes.

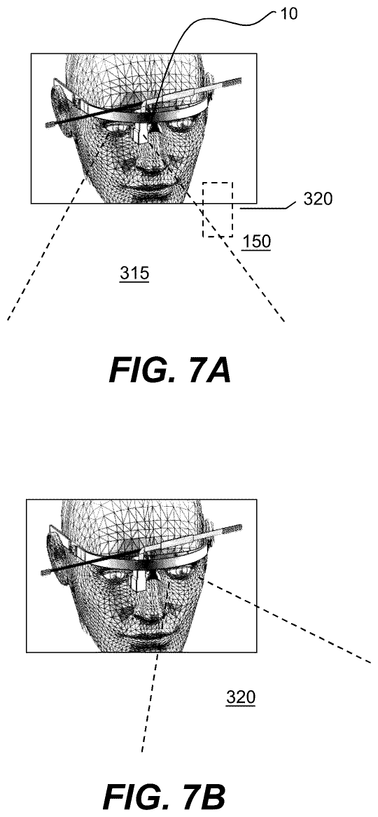

FIG. 6 shows two standard, straight-ahead lines of sight, one for central fixation for each eye of the viewer. RL1 is a normal or straight-ahead line of sight for the right eye and is central to the right-eye visible field 315 of FIG. 7A. LL1 is the normal or straight-ahead line of sight for the left eye and is central to the left eye visible field 320 of FIG. 7B with visible portion 325 (represented as dashed lines) of display apparatus 10 appearing in the nasal blind spot 150. Referring back to FIG. 6, relative to the viewer anatomy, display apparatus 10 defines a display axis K that lies along a diverted line of sight RD2 that is defined for the right eye in this example. In general, oblique or diverted line of sight RD2 corresponds to the viewer's line of sight when the right eye is diverted nasally toward the side of the contralateral, unobstructed eye, in this example. FIG. 6 also shows the change in line of sight of the unobstructed left eye when viewer gaze is diverted leftward, in this example labelled LD2. Relative to a normal or straight-ahead line of sight along RL1, display axis K is diverted at least 30 degrees or 9 degrees from RL1. Whether the display is configured for right-eye or left-eye visibility, the viewer's nose N blocks visibility of display apparatus 10 from the contralateral eye.

When the viewer diverts vision away from the head-on scene content and angularly toward the display apparatus 10, the generated image is visible to the right eye, appearing to be “positioned” within the world view of the contralateral left eye visible field, at optical infinity, but not obstructing any left eye visibility. As noted previously, the total visual field of the viewer is not reduced; the contralateral left eye is entirely unobstructed, and only a portion of the binocular field of view, contributed by the right eye, is reallocated.

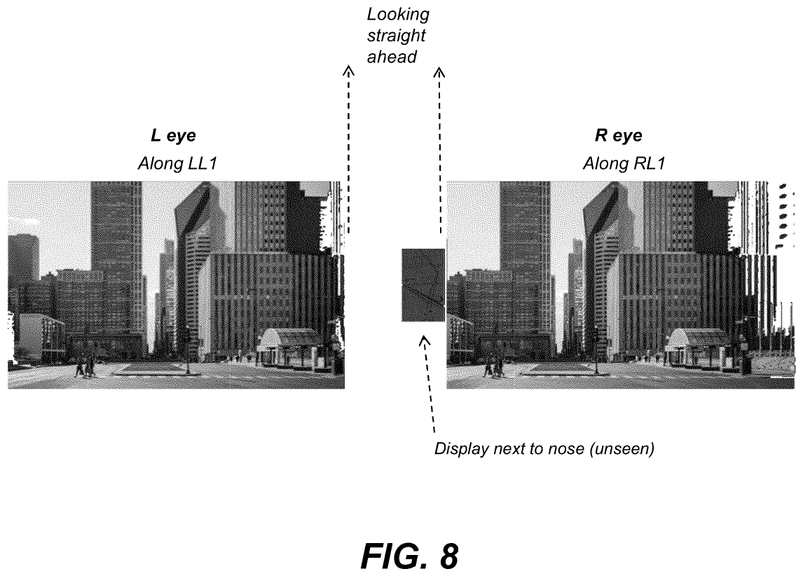

FIG. 8 shows left and right image normal visual fields and generated digital content from the display apparatus 10 that is positioned within the nasal field (in dark gray) and only discernable in outline when the viewer looks straight ahead. The unseen digital content can be integrated with the normal visual field of the contralateral unobstructed eye when the line of sight is diverted towards the display by the viewer.

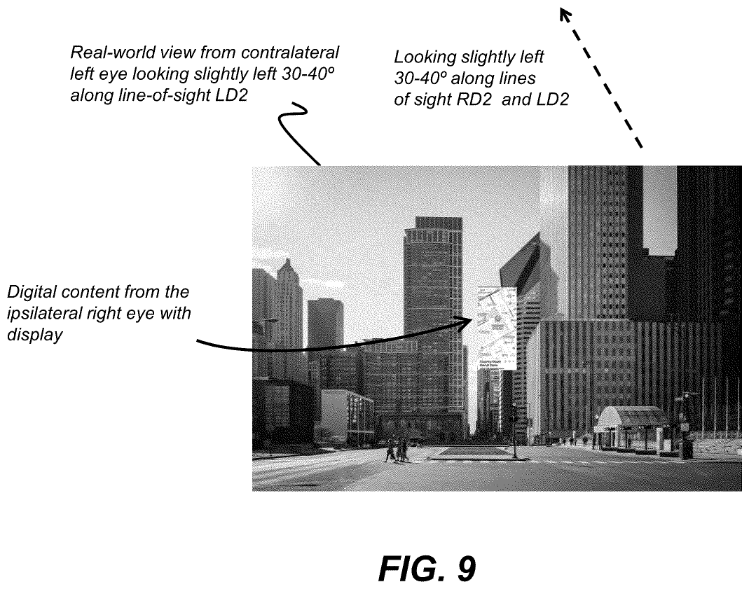

FIG. 9 shows composite view with the augmented reality digital content components added, visible when the viewer looks slightly to the left along lines of sight RD2 and LD2. More generally, the AR view is available when the digital eye is diverted toward the nasal blind spot.

It should be noted that in these exemplary illustrations, with the device situated for visibility by the right eye, using a leftward gaze of the right eye provides visibility of the display content; if the device is alternately situated for visibility by the left eye, this behavior is mirrored for the left eye, with viewer gaze correspondingly diverted rightward.

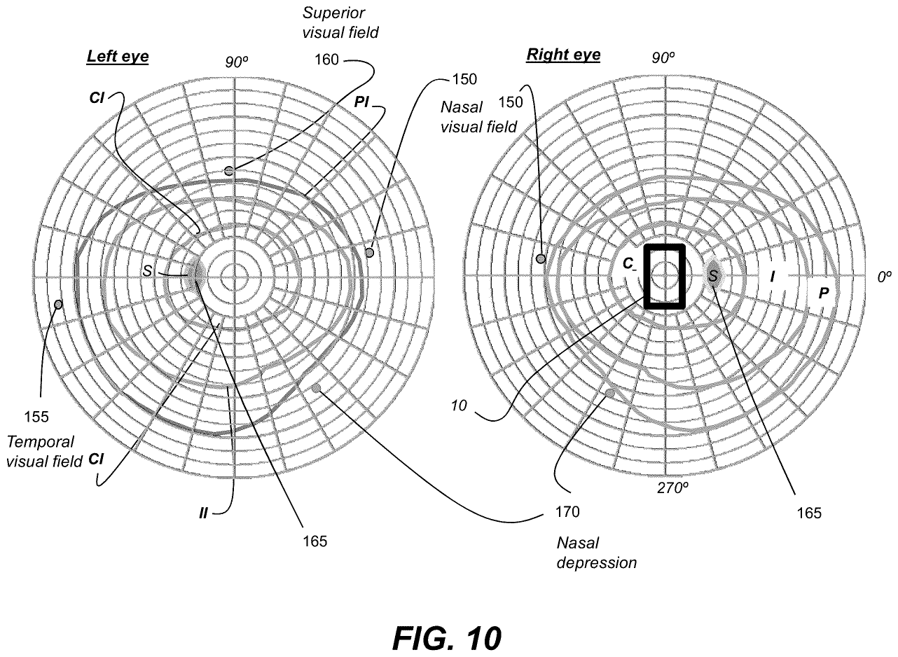

Display Apparatus Position is Unique and Necessary for the Use of the Invention. During forward gaze of the viewer, the monocular, opaque display may be positioned within the nasal blind spot as well as peripheral and intermediate visual field so that it can be observed when viewer gaze shifts toward the display. When viewer gaze is thus redirected toward display apparatus 10, as in FIG. 9, the generated image content then lies within the high acuity central visual field of the eye, as represented in FIG. 10. In this condition, the digital image content generated from display apparatus 10 may appear to be superimposed upon the real-world view of the “contralateral” or “unobstructed” eye.

This superimposition utilizes the confluence of several factors. Because the display apparatus 10 is opaque, only isolated digital content is presented to the eye; no view of the real world or multiple planes of focus interfere with the visualization of the digital content presented to that eye as is present with “see-through” augmented reality devices in which digital content and the real world are seen simultaneously by one eye in two or more different planes of focus. Depending on the individual and the position of the display apparatus there may still be a small amount of real-world image content that appears around the edges of the display. The innate neurophysiologic “Binocular Rivalry” process causes ocular dominance to oscillate between the two eyes, both of which simultaneously view separate, readily perceived images without a visual conflict or with the visual dissonance common to “see-through” type displays. A stable mosaic image is more likely to result than with a “see-through” type display and provides a robust composite image that can be readily comprehended.

The perspective views of FIGS. 6, 7A, and 7B show a basic arrangement for a wearable digital display apparatus 10 that defines the allocation of binocular space in the visible field, as used herein, and defines one eye position for a “digital” eye that can view a displayed digital image and can allow the other, contralateral eye to be an unobstructed eye, capable of viewing only the conventional visible field, and not viewing any portion of display apparatus 10, according to these embodiments. In the monocular arrangement, display apparatus 10 is positioned along the edge of the nose, occupying the medial or nasal visual field 150 for one eye (the “digital” eye).

The optimal positioning of the display apparatus of this invention is reliant on proper positioning in the X (medial-lateral), Y (superior-inferior) and Z (depth or distance to the eye) planes as well as rotation about the X axis (pitch) and Y axis (yaw). While X and Y translational adjustment is common to many augmented reality devices to center the display in front of the pupil due to differences in facial structure including interpupillary distance, rotation about the X and Y axis is not employed in these devices. An adjustable Z plane is typically not used with see-through and pass-through AR devices as the plane of the display is a fixed distance from the eye due to the mechanics of the headset and their reliance on combiner or waveguide optics to create a large exit pupil. For this invention a given set of optics may be optimized for an eye relief (distance from the eye) of 12+/−4 mm, and depending on the individual user, require translational adjustment in the Z plane.

For all see-through and pass-through display devices, rotation about the X (pitch) and Y (yaw) axes are not relevant to proper positioning. As detailed below, the next to nose ultra near to eye position of this display apparatus mandates alignment to the eye in a direction oblique to the axis of the normal line of site requiring rotation about the X and Y planes. This is unique to the structure and function of this invention and is distinct from previous augmented reality and virtual reality devices in the prior art.

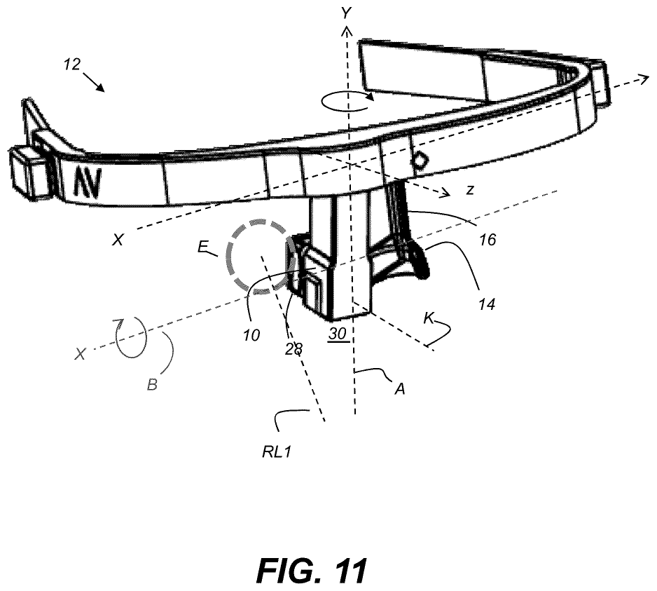

In the example of FIGS. 6, 7A, and 7B, monocular display apparatus 10 is mounted on an adjustable head band 12 as a type of supporting frame. In FIGS. 11-15, the axes of translation and rotation are indicated. In the examples given, display apparatus 10 can be shifted along the medial-lateral X axis a distance of approximately +10 mm to assume an optimal position at the medial eye next to the nose. This can be accomplished by any number of mechanical methods well known to those practicing the art and includes a ball joint to angle the nose piece, a sliding mount, or using individual slots in the head frame to place the nose piece closer or further from the midline of the head band. Other alternative embodiments are possible. If the display is mounted on the piece that straddles the nose bridge, it will by default be positioned next to the nose.

A rotating connection at the intersection of the display apparatus and the head band allows rotation with respect to the head band 12 frame, at least over a range of +/−10 degrees or more about the vertical Y axis (yaw or rotation axis A). A flexible joint can allow the display apparatus to be rotated about the X axes (pitch or rotation axes B) at least over a range of +/−5 degrees. These two adjustments, Yaw and Pitch, are necessary so that the display apparatus can be appropriately disposed adjacent to the bridge of the nose N, along the nasal edge (nasal depression 170) of the visible field and aimed toward the eye position of the viewer on axis when the digital eye is deviated to look at the display and at an oblique angle relative to the normal line of sight at the eye positions defined below.

The normal line of sight for the right eye position, defined by head band 12 design, is shown as RL1 in FIG. 6. An enclosure 30 is a housing that can be disposed near a nasal edge position, advantageous for enabling use of the visual principles described hereinabove for allowing visibility of the full visible field with AR capability available with diverted gaze. It can be noted that deployment and use of display apparatus 10, and its described mechanisms of rotation, is not limited to a structure such as head band 12. Other head and face support frames are possible to define a line of sight for a viewer, based on well-defined anatomical relationships for the viewer population. Support from external devices, such as helmets is also possible.

According to an embodiment of the present disclosure, the frame provided by head band 12 may be situated at and above the brow supported by the skull at the superior orbital rims, with support from a nose piece 14 seated along the bridge of the nose; the head band 12 can rest seated at the ears, so that it secures enclosure 30 holding display 24 and associated optics, lying near or against the face, next to the nose, at the endocanthus of the eye, at the most medial peripheral margin of the normal visual field with respect to the straight ahead line of sight of the first eye. Alternatively, enclosure 30 holding display 24 could be connected to the nosepiece directly.

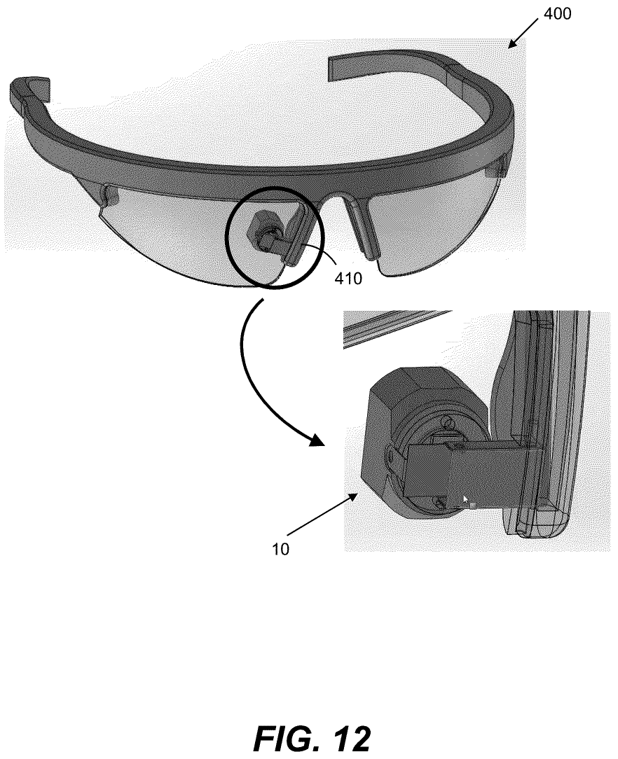

To compensate for differences in facial anatomy of the viewer population, enclosure 30 of display apparatus 10 may be configured to allow appropriate Y (superior/inferior or up/down) and X (medial/lateral or left/right) shift as well as rotation adjustment about axis A (yaw) and B (pitch) for optimal positioning of display apparatus 10 for each viewer. These directions are indicated in FIG. 11. Shift in the Z direction, nearer or closer to the eye, also via a mobile or hinged mechanical apparatus, will provide optimal eye relief. One embodiment of this type, with the display apparatus 10 based upon the nose piece 410 of a pair of spectacles 400, is seen in FIG. 12. When display apparatus 10 is suitably positioned, display apparatus 10 can direct image-bearing light toward the viewer's eye from an angle that is oblique from the straight-ahead line of sight of normal vision, such as divergent at least 30 degrees or 9 degrees from the normal line of sight of the viewer, RL1 in FIG. 6. Display apparatus 10 position relative to the viewer's right eye position is used in this example; that is, the right eye is considered the digital eye in examples given herein. However, display apparatus 10 position can be mirrored at the contralateral left eye, if desired by the viewer, or may be disposed in some other suitable position for viewing, without limitation.

Positioning medial to the eye and next to the nose at the endocanthus of the eye is a unique arrangement necessary for successful utilization of the Applicant device for AR display. This positioning is unlike and distinct from positioning at other regions close to the eye or face beyond or within the peripheral visual field that do not obstruct the normal straight-ahead field of view. Only the medial position is unique in that the display can be partially situated in an already existing but entirely accessible “blind spot.” Furthermore, this is the only position that falls within the area of binocular representation. Looking at the display in other positions does not provide an overlapping visual field with the contralateral eye and creates a permanent area of obstruction in the visual field, diminishing usefulness of the display apparatus 10. Furthermore, these other peripheral visual field positions, not within the region of binocular representation, would not be able to produce a visual fusion “mosaic” utilizing binocular rivalry and cannot produce the AR user experience of this invention.

Mechanisms of Positioning and Alignment of the Invention. It can be appreciated that the imaging requirements for obtaining the visual response for AR presentation that preserves the visible field as described previously, can be particularly demanding and that conventional approaches to HMD design fail to address these requirements. Among desirable design features for the imaging apparatus are the following:
(i) size and form factor of the display must be suitable for positioning adjacent to the nose of the viewer, without encroachment on the central or macular visual field of view, accessible to the region of binocular vision, with the imaging objective within 16 mm of the eye surface,
(ii) capability for precise positioning for the optical system in order to properly align the display optics to allow integration of the generated digital content with the real-world scene content and to adapt to the facial anatomy and line of sight of the individual viewer, and,
(iii) stationary and stable support for the display apparatus.

The perspective view of FIG. 6, as discussed above, shows a configuration of head band 12 and display apparatus 10 mounting according to an embodiment of the present disclosure. As noted previously, the support functions of head band 12, as shown in the illustrated embodiments, can be provided using other objects of headgear, wearable clothing, or equipment that is worn on or about the head of the viewer. Head band 12 or other supporting headgear provide a stable support mechanism for suspension of display apparatus 10 relative to the eye and overall anatomy of the wearer. A nose piece 14, configured with a base for seating along the bridge of nose N, can provide a measure of additional support as well as serve for variable horizontal and height adjustment (secondarily influencing pitch), as well as serve as a direct support for the display apparatus, as described subsequently.

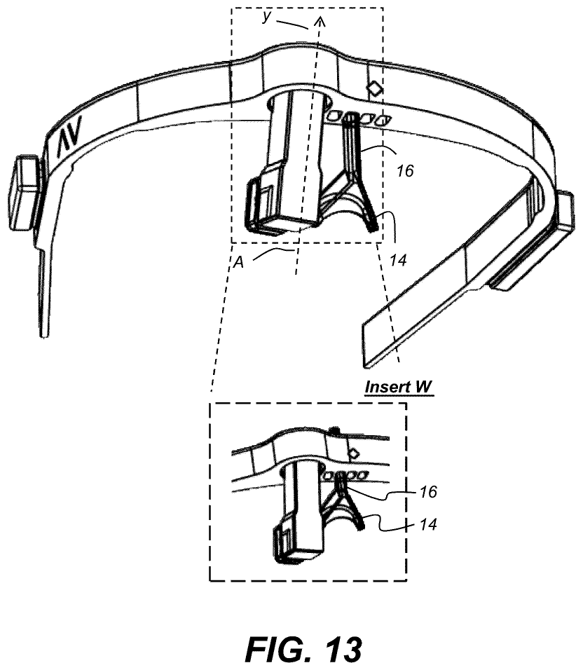

The enlarged view of FIG. 11 and subsequent details in FIGS. 13-16 show support and positioning features for head band 12 that support display alignment in more detail. Four degrees of movement for viewer adjustment with respect to standard mutually orthogonal x, y, and z axes can be provided, with the origin (0,0,0) centered along the top of enclosure 30. Mutually orthogonal vertical and horizontal axes are assigned relative to standard viewing posture for a viewer in an erect seated or standing position:
(i) x-axis translation, adjustment, providing suitable horizontal position of enclosure 30;
(ii) y-axis translation, adjusting the vertical height of enclosure 30;
(iii) z-axis translation (nearer to or further from the eye) which depending on the mechanism, provides focusing of the generated display content and/or determining eye relief distance;
(iv) rotation of enclosure 30 about the y-axis as rotation axis A, or yaw which may be based on the head frame, nose piece or elsewhere, allows the angular displacement of display apparatus 10 and proper alignment during elective visibility of the display to the eye that is averted from straight-ahead vision; and,
(v) Rotation of enclosure 30 about the x axis as rotation axis B or pitch adjustment can be provided to allow alignment with the degree of upward or downward angulation of the eye. According to embodiments shown herein, tilt adjustment for enclosure 30 is fixed at approximately 10 degrees for simplicity, but other embodiments utilizing a dynamic mechanical connector or mobile hinge near the headband, nose piece or elsewhere near the display apparatus are possible, allowing rotation about the X axis an additional+/−5 degrees.

Pitch is most simply and directly adjusted by rotation about the X axis to achieve best alignment with the eye. However, the amount of Pitch needed for alignment secondarily relates to height of display apparatus 10 relative to the vertical position of the eye of the viewer, with respect to position along the y-axis as shown in FIG. 11. Consequently, translation along the Y-axis can also help to properly align the display to the eye of an individual if the enclosure pitch is fixed. This can be provided by length of shaft 16 and adjustment of height of nose piece 14 that is configured to seat along the bridge of the nose. Adjustment for pitch relative to the angulation of the eye can also be obtained secondarily by placing a hinged mechanical connector at the head band that decreases or increases the angulation of shaft 16 and nose piece 14 thus increasing or reducing the distance and angle between head band 12, the nose, the eye and the display apparatus. According to an embodiment of the present disclosure as shown in FIG. 13, display apparatus 10 can be provided with a set of alternative size nose pieces 14, individually selectable, each having a shaft 16 of a different height or curvature. Insert W shows a very small shaft 16 length from nose piece 14, for example. Coupling of shaft 16 within the supporting frame provided by head band 12 can alternatively use a friction fit or a geared-ratcheted fit at the shaft coupling to adjust the height for different viewers. Pitch adjustment can directly be provided if the enclosure is hinged or attached to the head band 12 with a flexible joint or if the enclosure is coupled to a helmet or other stiff surface that allows rotation of the enclosure 30 support frame about the x axis.

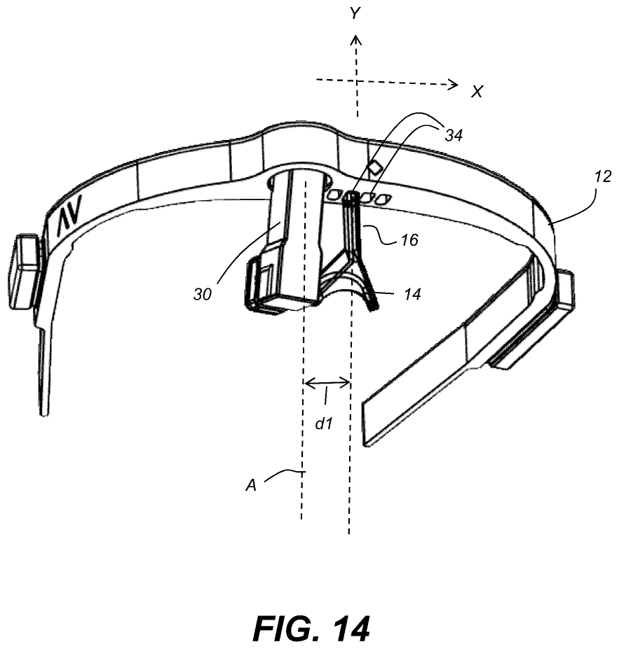

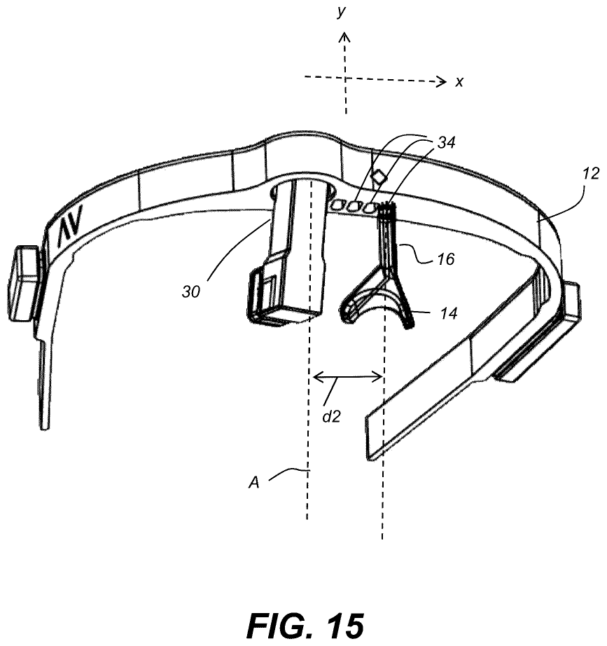

In the embodiment shown in FIGS. 14 and 15, a range of holes 34 is provided in head band 12 cooperate to provide adjustment in the lateral direction, along the x-axis, to effectively set a variable distance between enclosure 30 and the nose of the viewer, for example. This allows for variable inter-pupil distance (IPD) of the individual viewer and brings the display closer to or further from the mid pupillary line and the region of central or macular vision. Other cavity arrangements for coupling shaft 16 can be provided as alternatives to the range of holes 34 to facilitate appropriate lateral positioning of the display enclosure 30 for the viewer. For example, a mechanical sliding mechanism at the interface of the display enclosure and head band could accomplish the requisite X axis translation.

FIG. 14 shows obtaining a lateral distance d1 between nose piece 14 and enclosure 30 on axis A with the shaft 16 coupling at one of the holes 34. FIG. 15 shows adjustment between nose piece 14 and enclosure 30 to an alternate lateral distance d2, by coupling of shaft 16 in a different hole 34. It should be noted that other mechanisms can be employed for adjusting the d1/d2 or IPD distance, including a shaft coupling arrangement that provides for shaft 16 repositioning within a single elongated slot, for example, or use of other mechanisms that are actuable to translate enclosure 30 position, or axis A position, horizontally relative to nose piece 14.

Some amount of enclosure 30 rotation about the y-axis, or vertical rotation axis A (yaw) may be necessary for obtaining proper alignment of the display axis K that allows display apparatus 10 to provide the full benefit of AR capabilities, with generated digital image content superimposed against a portion of the real-world scene background, the generated image centered about the display axis K, as described previously. Rotation about the y-axis, enclosure rotation axis A provides a measure of yaw adjustment and can also help to compensate for IPD differences between individual viewers.

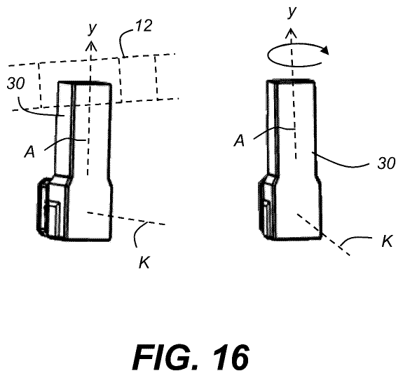

Use of Y axis rotation or yaw, is distinct from the prior art in which IPD correction can only be performed via translation in the X direction. FIG. 16, shown with head band 12 removed, shows rotation of enclosure 30 about the y axis or rotation axis A. Only a limited rotation of enclosure 30 about the vertical A axis, such as with an overall range of less than 30 degrees, for example, may be sufficient for obtaining suitable alignment of the display axis K for the viewer.

According to an embodiment of the present disclosure, rotation axis A is nominally orthogonal to display axis K (to within +/−1 degrees). As FIG. 11 shows, ocular 28 lies between the intersection of mutually orthogonal axes A and K and the defined eye position E. It can be noted that a few degrees of rotation (+/−5 degrees) about the x-axis (Axis B in FIG. 11) or pitch will allow for improved alignment for an individual viewer. The degree of pitch adjustment needed will depend on the adjustment in the Y axis (height of the display apparatus relative to the eye) and the individual facial/eye characteristics of the user. As it can be observed from FIG. 11, display axis K intersects rotation axis A. The point of intersection of axes A and K is offset by some distance from the normal line of sight shown as RL1 and described with reference to FIG. 6. Eye position E can be defined at the intersection of normal line of sight RL1 that is defined by head band 12 or other support frame and display axis K.

Proper positioning of this device is fundamentally different from other types of augmented reality devices which typically only require translation in the X, Y and sometimes Z planes. For proper positioning of this invention, adjustment in Yaw as defined by rotation about the Y axis (rotation axis A) and adjustment in Pitch as defined by rotation about the X axis (rotation axis B) is required and for most individuals will be the dominant or only corrective movements required. Proper alignment of the display device with the deviated angle of gaze needed to see the image (line of sight RD2, LD2, display axis K-FIGS. 6 and 11) can only be achieved with these unique movements, directly resulting from the unique positioning of the display device at the medial aspect of the eye next to the nose and ultra near to the eye surface. In accordance with an aspect of the invention an AR display device is defined by a line-of-sight position normally occupied by the position adjacent to the nose (within and adjacent to the nasal blind spot) or the most medial peripheral visual field. At least four degrees of freedom including x rotation (pitch), y rotation (yaw), and x and y translation are necessary for proper alignment of display axis K with the deviated line of sight RD2, RDL. Situating the device at the endocanthus (the medial aspect of the eye) minimizes the importance of translation in the x and y directions and instead places greater importance on pitch and yaw for most of the movement needed for proper alignment. Furthermore, translation of the enclosure along the Z axis is required for proper eye relief and of the optics for focus—a feature not present with prior art “see-through” or “pass-through” devices.

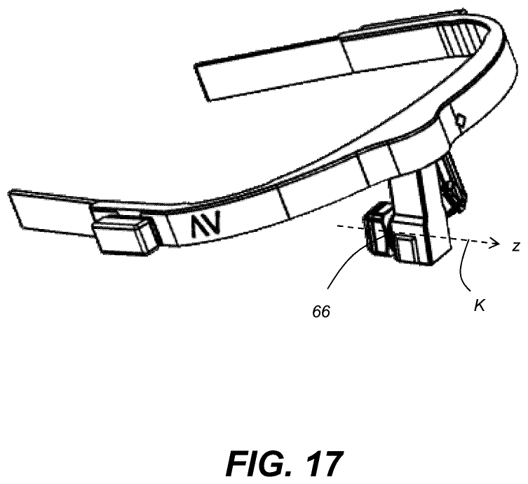

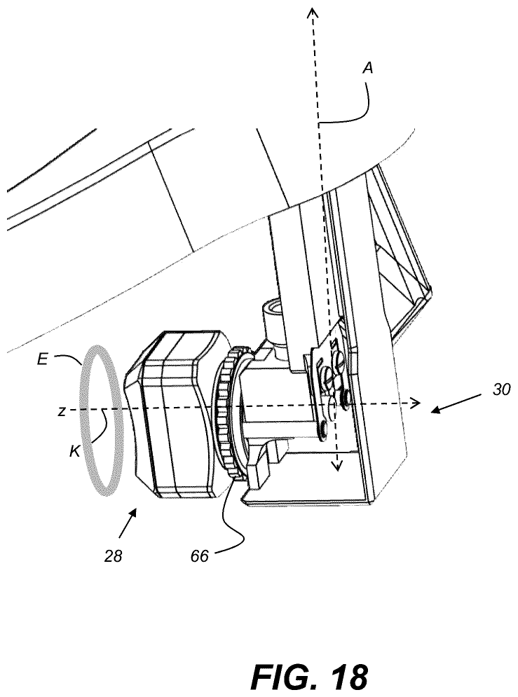

Referring to FIG. 17 and the enlarged view of FIG. 18 having components removed for improved visibility, focus adjustment 66, allows a variable range of translation along the z-axis, corresponding to display axis K, which changes the distance from the diffuser surface to the ocular in the case of a raster beam scanning device. Similarly changing the distance from the light source to the ocular in the case of a flat panel device allows for focus adjustment. This is described in greater detail in later sections. Movement can be provided for the display apparatus by a thumbscrew focus adjustment 66 on enclosure 30 as shown in this embodiment or other mechanical means such as a sliding “tube within a tube” mechanism for the flat panel light source embodiment.

Z-axis movement of ocular 28 relative to the surface of the eye can allow the Applicant device to reduce the eye relief to an optimal position that is less than 16 mm, such as over the range of 12+/−4 mm, for example, the nominal position in one of the current embodiments. FIG. 12 shows a different structural embodiment in which the display apparatus is supported directly upon the nose piece and a hinged apparatus allows translation of the display apparatus in the Z axis to adjust eye relief.

It can be noted that embodiments shown herein employ nose support from nose piece 14 as one factor for providing stability for positioning of enclosure 30 optics. Nose piece 14 can be incorporated entirely into the structure of the head band, as in a pair of ordinary glasses or can be one component of a multi-point support system for enclosure 30, in cooperation with head band 12 or other headgear.

FIGS. 11 through 18 show a display apparatus in a typical embodiment in which the ocular is taller in vertical height than wider in horizontal width. This is commonly referred to as a portrait orientation. When width is greater than height, it is typically referred to as a landscape orientation. For this invention any ratio of height to width is possible although the portrait orientation offers advantages given the unique positioning of the display apparatus relative to the eye. The vertical space or height at the next to nose, endocanthus position allows for more distance without interference with the face than the horizontal distance or width which as described earlier for all embodiments is desired to be as small as possible to avoid encroachment on the macular or central visual field. This restriction due to typical facial features provides a unique advantage to the next to nose, ultra near to eye position mandated by the optics of this invention. Most mobile devices today including smart phones and tablets are typically used in a portrait orientation, similar to the optimized orientation of this invention. This allows for a greater applicability of popular image format and layout with the display apparatus of our invention.

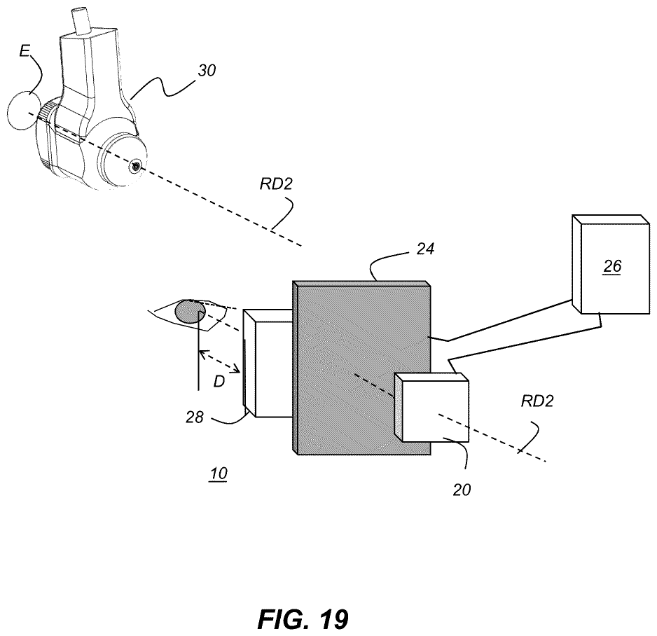

Display Apparatus with Camera or Sensor. The schematic diagram of FIG. 19 shows components of display apparatus with a camera 20 in schematic form, as aligned along line-of-sight RD2. Camera 20 is not used in some embodiments, such as that shown in FIG. 6, but can alternately be included, and adjustment features and practices are the same for embodiments of display apparatus 10 with and without camera 20. In the embodiment shown in FIG. 19, an optional camera 20, or other electromagnetic wave sensor, is disposed to capture image content along line-of-sight RD2, as previously described. The image content generated by camera 20 can be conveyed to an image processor 26 that is in signal communication with apparatus 10. A display 24, in signal communication with camera 20 and with image processor 26, is energizable to display image content acquired by camera 20, combined with synthetic digital images conveyed or generated by image processor 26 logic. Image processor 26 as shown schematically can represent multiple processors and includes the camera image processor as well as processing logic that generates or conveys synthetic content for overlay. An optical lens or lens array, eyepiece 28 is an ocular that essentially collimates display 24 content for visibility in the near-to-eye arrangement shown. The apparatus 10 can be configured so that the image from camera 20 is viewed on display 24, and can be configured by those skilled in the imaging software arts to provide an image that matches that region of the FOV reappropriated by the device, effectively compensating for the obscuring silhouette of display apparatus 10 and camera 20, as described in more detail subsequently. Collimation of the display 24 content provides both a single plane of focus between the real-world scene from the camera and the digitally generated content and presents them co-axially.

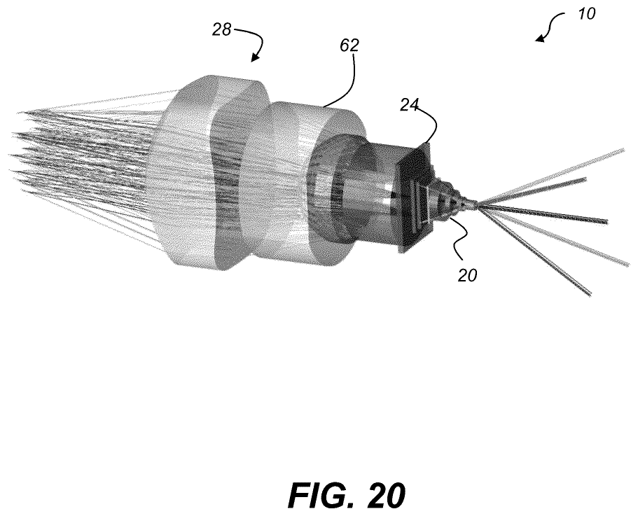

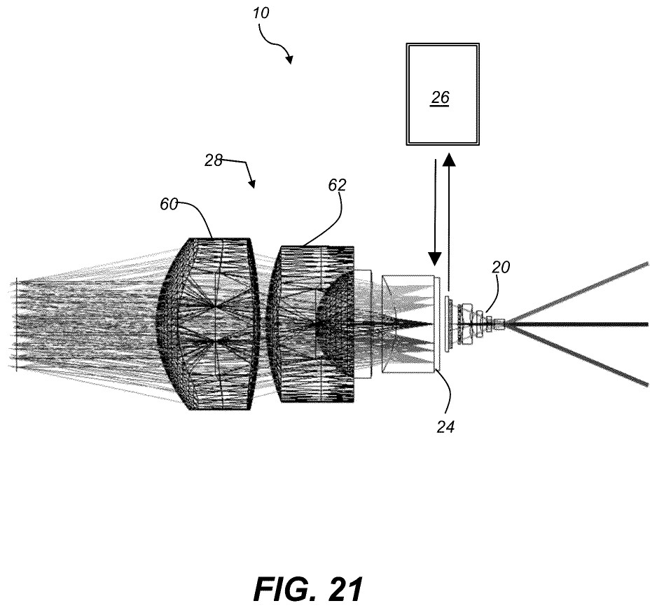

FIG. 20 is a perspective view of display apparatus 10 with the eyepiece ocular 28 and field lens 62 positioned in front of the flat panel display 24 with a camera 20 at the front. FIG. 21 is a schematic view of the display apparatus 10 shown in FIG. 20. Camera 20 input is sent to the processor 26 where it is combined with the digital content and then sent to the flat panel display 24. The camera 20 center line of axis and plane of orientation can be exactly matched to that of the flat panel display 24. Processor 26 may generate the digital content of image 44 or relay it from another source. Processor 26 may spatially co-register camera image 40 and digital content of image 44 or may simply superimpose the two.

This embodiment is different than see-through, wave guide AR display devices with cameras which are unable to place a camera directly in the same line of sight as the digital content (which is directly in the primary field of view at all times) and must by necessity position the camera off axis from the digital content presented to the viewer. Differences in perspective between the camera and the user's line of sight can create inaccuracies in measurement or localization. Additionally, this embodiment avoids multiple planes of focus created by digital content and the real-world scene using see-through AR display devices-a source of visual dissonance. Furthermore display 24 image content can be scaled and positioned so that the outline of the generated image conceals the underlying optical and camera 20 components from visibility to the viewer. This embodiment is also different than video pass-through AR display devices where cameras and a display screen provide the only visualization of the real world which may be problematic when the camera or display screen are not in use or fail, and the user is unable to see their environment and lose situational awareness. This creates a potential problem if the user is performing a task in a dangerous environment. This embodiment avoids the possibility of complete loss of situational awareness if a device failure occurs as the display apparatus does not block the normal field of view when not in use.

Flat panel display 24 can be a device that employs any suitable display technology, including OLED, microOLED (uOLED), LED, micro LED (uLED), LCD, or LCOS technologies, for example. A raster scan display, such as a laser-scanned display, or other scanned light source display type, can alternately be used in place of a flat panel shown and can be provided as described in commonly assigned U.S. Pat. No. 11,340,451 to Kessler et al., incorporated herein by reference.

The eye relief of display apparatus 10, that is, the distance from the cornea of the viewer to the first optical surface of the ocular, eyepiece 28, is configured to be disposed within the focal distance (the object focal length) of the eye at an eye position E defined by the apparatus optics, commonly defined as <16 mm, and shown as distance D in FIG. 19. This embodiment is designed at a nominal eye relief distance of 12 mm.

The size of the field of view captured by camera 20 may periodically need to be adjusted so that it accurately reflects that same size field of view in the contralateral eye that is obstructed by the ipsilateral digital eye display apparatus 10. This adjustment may be done electronically within image processor 26. Image-based techniques or sensor-based techniques may be used to guide the image-sizing and boundary-matching process using electronic and software utilities well known to those practiced in the electronic image manipulation art.

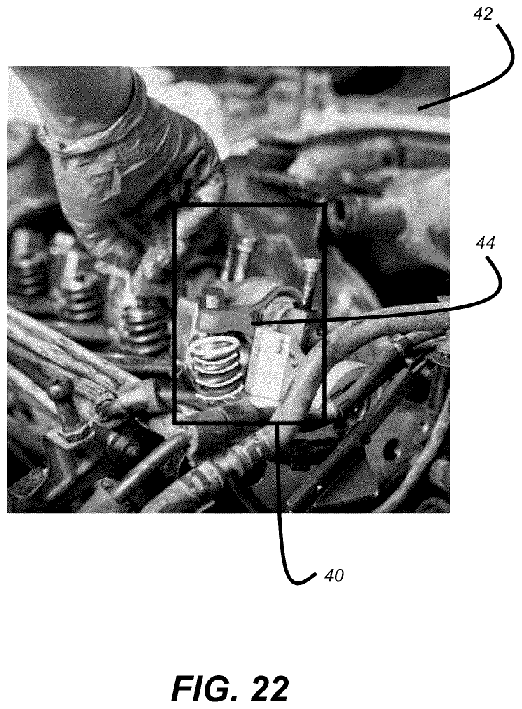

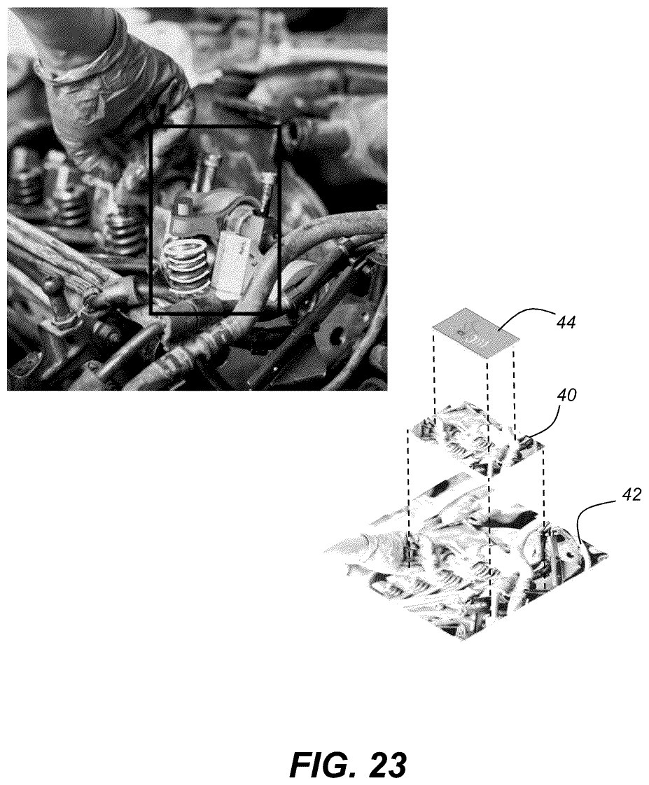

FIGS. 22 and 23 show aspects of the augmented reality imaging provided by display apparatus 10. FIG. 22 is a representative view of the compound image that is available to the viewer in a typical example. Following the right-eye display apparatus 10 configuration used herein, by looking to the left along lines of sight RD2 and LD2, the viewer does not perceive the presence of camera 20. The camera image 40 is outlined over the unobstructed contralateral visual scene 42 that is presented to the viewer. A further generated or synthetic digital image 44, such as an informational schematic, graphic, text or other image for example, can be overlaid onto camera image 40 to provide the augmented image. The augmented image content may or may not be co-registered with the actual, real-world scene, depending on the task and the format of information intended by the application.

FIG. 23 shows an exploded view of the compound augmented reality image of FIG. 22 that displays to the viewer. The rectangular region of camera image 40 is obscured from normal right-eye viewing along line-of-sight RD2 by display apparatus 10. The camera image 40 is sized so that it completely fills the blocked region of visibility due to the camera 20 and associated optics and support components of display apparatus 10, providing a type of “video pass-through”. Camera image 40 and digitally generated image 44 can be independently generated and then combined by processor 26. Combination can be performed so that processor 26 accurately spatially co-registers the different elements of the combined video image presented on display panel 24 that consists of camera image 40 and generated image 44. The co-linear and co-planar arrangement of this embodiment allows a high degree of spatial co-registration.

It should be noted that in the case where display apparatus is alternately situated at the left eye nasal visual field 150, so that the left eye is the digital eye, the imaging behavior of FIGS. 22 and 23 would be “mirrored”, so that the display in the left nasal field is clearly visible only when the viewer looks slightly to the right (toward the nose), by about 30 degrees or more.

The spatial co-registration can be achieved by many different methods well known to those practiced in the augmented reality art, including boundary matching, object matching, pixel by pixel matching, artificial intelligence image analysis, or using an emitter and sensor localization technique such as SLAM (sensor localization and mapping). The images need to be sized similarly, and their corresponding objects matched to reduce visual interference caused by dissonant or misaligned visual elements.

For embodiments using camera 20, a novel aspect of the present disclosure is the registration of camera 20 with flat panel display 24; their image content can be closely matched along the center axis of their respective lines of sight, and orientation of their respective image planes, due to the colinear relationship of the axis of the camera or sensor panel and the light source panel (not shown). This arrangement allows for a high degree of accuracy for spatial co-registration of digital content, camera content, and real-world view, as represented in FIGS. 22 and 23. This accuracy cannot be achieved by see-through systems wherein the line of sight of the viewer, as seen through the transparent combiner or waveguide, is necessarily different than the line of sight of any camera or sensor positioned on the supporting hardware (they are not colinear).

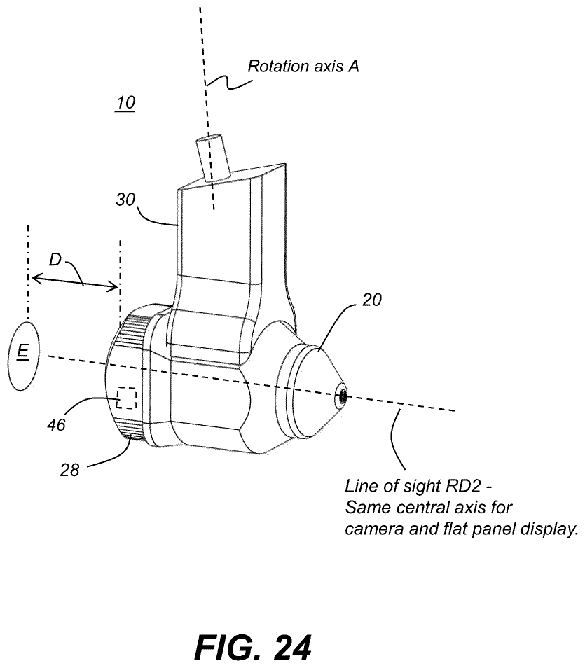

FIG. 24 is a perspective view of an embodiment of a display apparatus 10 with camera 20, one example of display apparatus 10 previously described, with enclosure 30 shown without connection to a supporting headpiece or other harness. The position of viewer eye position E defined along the line of sight is shown. Both camera 20 and flat panel display 24 align to the same center axis of orientation. An enclosure or housing 30 is used to aim the display axis and provides a protective enclosure for component mounting and convenient passageway for wire routing. Enclosure or housing 30 can be suspended from a headset or head band or nose piece and can be adjustable in position to seat display apparatus 10 against, or in close proximity to, side edges of the viewer's nose.

According to an embodiment of the present disclosure, an optional gaze sensor 46, such as an additional camera device, may be provided within, or adjacent to, enclosure housing 30 to detect viewer gaze direction. In signal communication with processor 26, gaze sensor 46 may be configured to indicate when the viewer gaze is directed toward display 24. In turn, processor 26 can alternately activate or de-energize the display based on viewer attention.

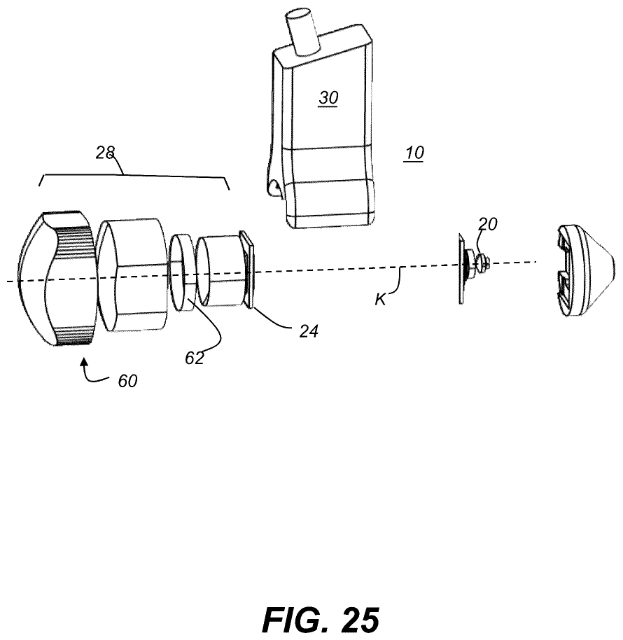

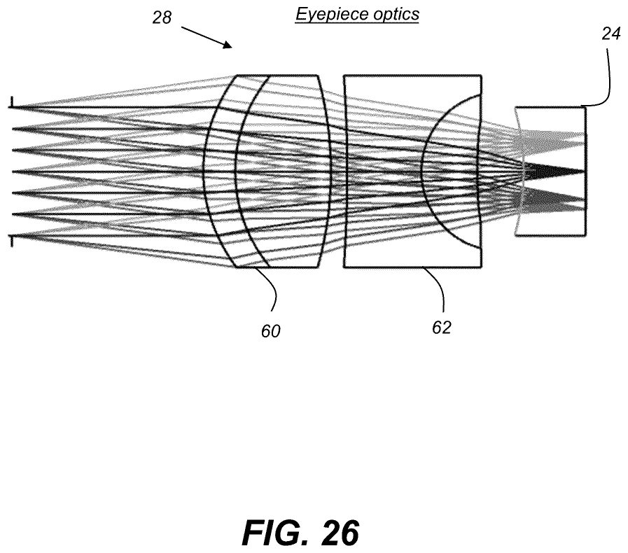

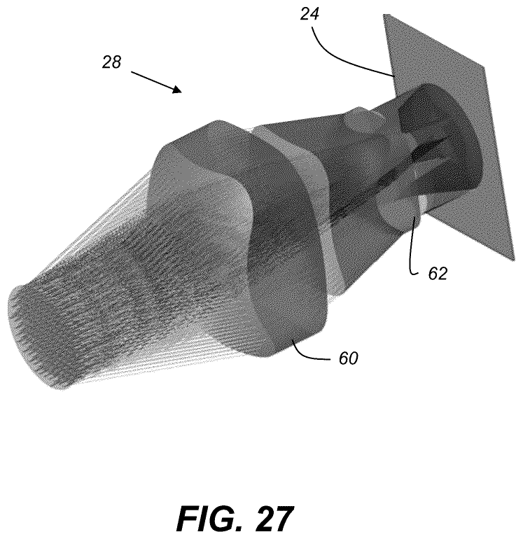

FIG. 25 is an exploded view of display apparatus 10 components in a camera embodiment. FIGS. 26-29 show optical components of display apparatus 10. Flat panel display 24 emits image-bearing light to eyepiece 28. Eyepiece 28, shown in detail in FIGS. 26 and 27, forms a magnified real image of the flat panel display 24. Eyepiece 28 can include a doublet 60 and a field lens 62. An objective can be positioned near flat panel display 24. It should be noted that, with respect to visibility along display axis K, the displayed image that is presented at eyepiece 28 is larger than and can conceal the optical components that are arranged behind the display, a configuration important in order to reduce unnecessary obstruction of the line of sight, as shown in FIGS. 26 through 28, for example.

Focusing. According to an embodiment of the present disclosure, a diffuser (not shown) or other mechanism that alters distance between a raster beam scanning light source and display optics can be used to allow adjustment of focus for improved accommodation of the display. The diffuser can be positioned between lens and display components to effectively adjust focal length.

Where a flat panel display is used, for example, with a viewer's eye at distance L from the flat panel with displacement distance d (shown using uppercase D in figures herein), with a focal length f, the image of the flat panel can be adjusted using the relationship:

$$L = {f}^{\frac{2}{d}}$$

For example, with a nominal 20 mm focal length, movement of the flat panel display by 0.2 mm, with the image at infinity, can be seen by the viewer at:

$${20}^{\frac{20}{0.2}} = 2000 mm$$

In terms of diopters (1/distance in meters), this means 0.5 diopters. With panel displacement of 3 mm, the effective distance is 1 m, the equivalent of 1 diopter accommodation for the digital eye.

For other light sources, for example, with a raster scanning type display, other mechanisms can be incorporated to adjust the position of the optics relative to the light source and change the focal length of the system.

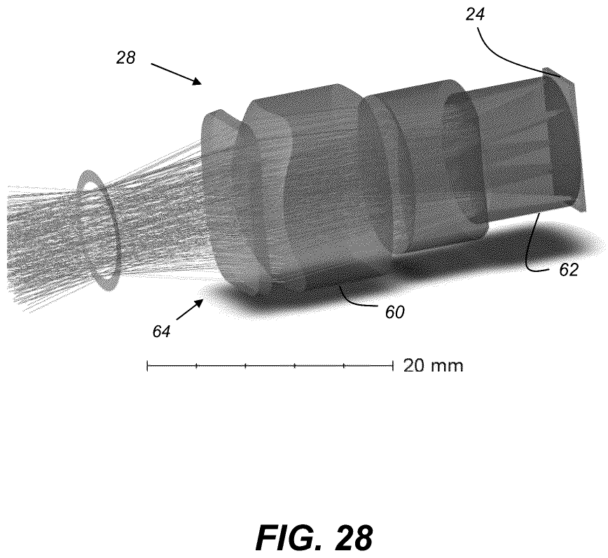

For the majority of the viewing population, accommodation of +/−3 diopters is feasible; however, image quality can be compromised. Thus, a reduced range of accommodation values may be more suitable, such as a range of +/−1.5 diopters, or 0.5 to 2 diopters, for example. Prescription inserts can alternately be provided using thin lenses in front of the optics. FIG. 28 shows use of an insert 64 in this manner.

Optical Design and Display Apparatus Position. Doublet 60 can provide the eyepiece with color correction and a field lens and can alternately be provided by a pair of lenses. Aspherical surfaces can be used, since there is no stop image and thus no suitable position for an aspherical surface to deal with spherical aberration. There can be two aspheres, one at the front end on the eye side and another on the field lens, for example.

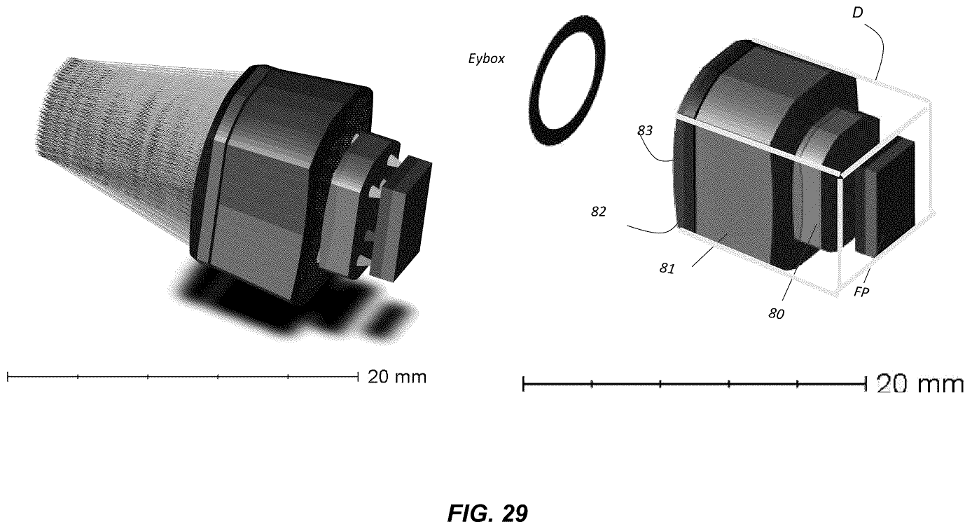

In an alternative embodiment of this invention, different optics may be used, employing a pancake lens. A pancake lens uses reflected and polarized light to fold and collimate the light path. The optical design is well described in previous patents including U.S. Pat. No. 11,340,451 Kessler et al., incorporated herein by reference. The purpose of this design is to shorten the length of the optical apparatus from the base of the flat panel light source (FP) to the exit of the optics. FIG. 29 show an optical design in which the optical system consists of a Doublet with the convex surface aspheric 80, and a pancake lens consisting of Plano convex Mangin lens with convex surface semitransparent 81, a wire grid polarizer 82 and a final aspheric lens 83.

As was described earlier, the length of the display apparatus is important so that the device may be situated behind the lenses of a typical pair of glasses yet still allow for sufficient eye relief. Assuming a total distance available from surface of the eye to the lenses of pair of glasses of 25 mm or approximately one inch, and an eye relief of 10 mm, it is necessary to have a total length of the display apparatus 15 mm or less. Even shorter display apparatus length is more desirable as it allows for more freedom of movement for adjustment, less interference between the display apparatus, and the lenses of the glasses, and a more inconspicuous, more aesthetic appearance. According to this embodiment of the present disclosure, FIG. 29, using a pancake lens, the components of eyepiece 28, a flat panel light source, and a focusing mechanism, fit within an enclosure less than 15 mm in length (depth D).

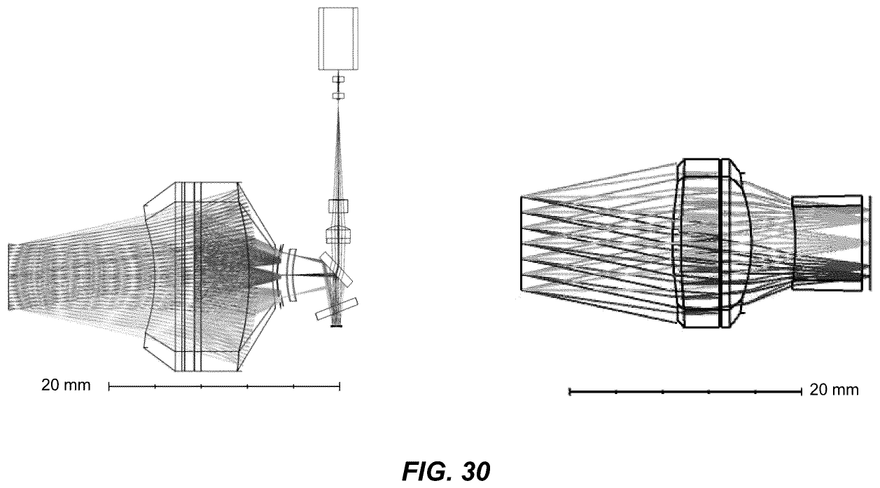

FIG. 30 compares two embodiments, one using a laser beam scanning light source and a pancake lens, the other using a flat panel light source and a pancake lens. Note the significant shortening of the length of the display apparatus when a flat panel device is used.

The use of a flat panel light source and pancake lens optics specifically designed so that the display apparatus is positioned with the ocular to lie within the object focal length of the eye (<16 mm) optimally with an eye relief of 8-10 mm is what enables this particular embodiment to sit “behind” the lenses of spectacles or other corrective or protective lenses. Only by using the combination of a flat panel light source and optics incorporating a pancake lens, with optics specifically designed to be ultra near to the eye and focus the light source image on the retina, can this positioning be achieved. According to an aspect, an AR device having a size and volume specifically enabling a display apparatus to occupy the position at the medial aspect of the eye, next to the nose, constrained by the geometry of the face and able to sit behind the lenses of a pair of ordinary spectacles, is provided.

User Experience Advantages of Display Apparatus. Utilizing the nasal blind spot and the most medial peripheral field of view by positioning a display at the medial aspect of the eye adjacent to the nose requires restrictive structural and positioning design elements to be successful. It must occupy less than the limited facial spatial volume allowed, must have optical and structural elements to allow positioning ultra near to the eye, and must utilize a unique set of mechanical adjustments different and distinct from other AR devices. These characteristics are not described in the prior art of Augmented Reality devices.

Using the Applicant's visualization technique, an opaque display merged with the contralateral eye real-world view, provides a type of “fusion reality” in which only a portion of the binocular visual field, along and within the nasal “blind spot” is reassigned or re-allocated by the device setup as a monocular portion for the rendered digital display. This technique takes advantage of the type of visual binocular rivalry “fusion” that is innate to the human visual system in combining left- and right-eye content. In the simplest use case, without a pass-through camera 20, the digital content is on an opaque display and does not clash with the real-world scene of the ipsilateral eye as is the case with see-through displays, thus presenting a simpler image for the contralateral eye and a more stable visual fusion. When camera 20 content fills in the missing area and provides an identical or nearly identical substitution for the ipsilateral eye, and then digital content 44 (as described with reference to FIG. 23) is superimposed and co-registered, the degree of visual interference dissonance is reduced, binocular rivalry dissonance is diminished, leading to a more stable visual fusion “mosaic.”

With a camera embodiment, because the plane of focus of the digital content and camera content can be identical, the degree of visual interference can be eliminated or greatly reduced. Because both types of input content are presented on a single flat panel device, their corresponding image qualities including brightness, resolution, contrast, shading, magnification, etc. can be made to be similar or identical. This also reduces visual interference and creates a more stable, easy to comprehend image. Because the contralateral eye is unobstructed, there is always a view of the real world to ensure real time situational/environmental awareness. This feature can be important in environments that may be hazardous. Other AR devices using pass through technique to merge digital content and camera content are immersive and should device failure occur, the user will be visually isolated from their environment, a potentially dangerous scenario.

The Applicant's fusion/reality system can be contrasted with optical apparatus that attempt to render “augmented reality” (AR) using other techniques. For example, waveguides are used in some AR systems, channeling the digital content into the visual path using glasses, visors, or other intermediary optical surfaces. Using light guide combiners can clutter the visual scene with confusing image content and artifacts, distracting the viewer or preventing some parts of the visual scene to be clearly perceived. In conventional see-through systems, the plane of focus of digital content is different than the real-world objects, causing visual interference. The digital content image quality may be very different in terms of brightness, shading, resolution and boundary lines causing visual interference. Other types of systems using projection methods, such as combiner or birdbath reflection for example, can cause considerable eye strain and distract from the visual scene due to stray illumination.

The Applicant system only directs light to the pupil of the eye and immediate surrounding iris, consequently there is no wide area facial illumination as occurs with commercially available waveguide systems. The limited illumination created by the Applicant's device allows for a more unobtrusive and less conspicuous usability, particularly important in situations where the user does not want to be detected. Since the information is not on a waveguide or combiner, it is not visible to an outside observer, insuring privacy and confidentiality of the projected information.

Using the Applicant system, the augmenting image content can be added to the visual scene of the viewer without being necessarily faded or made to be “transparent”. Unlike other “see-through” image augmentation techniques, the Applicant's method, for example, using an opaque display, allows the use of high contrast and bold colors and can provide AR display that includes black and very dark text or other markings. The Applicants system is able to display “true black” via the absence of light from a flat panel pixel source, not possible with “see-through” systems that must project a dark color pixel onto the waveguide or combiner in order to portray a “simulated” black-they cannot display an absence of light.

Because the Applicant system can be fabricated to be very small in size and to seat adjacent to nose and the nasal “blind spot”, only encroaching on the peripheral and intermediate visual fields, it does not interfere with the high acuity normal visibility of the visual scene, it can be particularly well-suited to the requirements of systems where on-demand information is needed while a maintained high functionality field of view and complete situational awareness is required.

Conclusion. According to an embodiment of the present disclosure, there is provided an optical apparatus for ultra-near-to-eye viewing comprising: a micro-display, optics for conveying the displayed image to the visual field of a viewer, wherein the eye relief is within the focal distance of the eye (within the object focal length of the eye, commonly defined as <16 mm), optionally with a camera or other sensor disposed at the rear side of the micro-display and configured to acquire image content along a line of sight, a processor configured to generate image content and to combine the generated content with the camera video content.

According to an alternate embodiment of the present disclosure, the image source that is energizable for emitting image-bearing light can be a flat panel display, a raster-scanned laser beam, or other raster scanning device.

According to an alternate embodiment of the present disclosure, the optics may include a pancake lens.

According to an embodiment, the display can be turned off to remove the display image from the display apparatus. This may be useful to preserve battery power when the display apparatus is not in use. It may also minimize distraction from stray light when the display apparatus is not in use. The micro-display of the display apparatus can be enabled or disabled using pupil tracking, for example.

With the Applicant device, the camera or sensor image can be turned off, or can be optionally included, so that only the digital content rendered to the display for overlay on the contralateral eye image. This simplifies the degree of digital content and requirements of visual fusion and, in certain use cases, may be a preferable method to provide only generated digital content. However, this arrangement may not allow true spatial co-registration between generated content and real-world content.

The Applicant has described embodiments of a wearable display apparatus for a viewer comprising:
a display having optics that form a collimated image of a display, wherein the optics are configured to be disposed against the side of the viewer's nose, at the medial aspect of the eye, within the visual range of a first eye of the viewer and outside the visual range of the contralateral eye; and
a camera disposed on the opposite, real-world side of the display apparatus, wherein the camera is configured to acquire image content obscured by the display apparatus along a viewer line of sight,
and wherein the display is aligned to the viewer line of sight and is disposed to overlay digital augmented reality content onto the unobstructed real-world view of the contralateral eye, either with or without the rendered camera image.

The first eye digital content may be seen as superimposed on the contralateral eye real-world view in a seamless fashion to produce a novel augmented reality experience (a visual “mosaic”) by taking advantage of binocular rivalry, an inherent neurophysiologic phenomenon. This next to nose, ultra near to eye, very small footprint configuration avoids obstruction of the high acuity visual field of the first eye, provides a large field of view, and eliminates the “real world” or digital content-related visual interference that degrades user experience.

The invention has been described in detail and may have been described with particular reference to a suitable or presently preferred embodiment, but it will be understood that variations and modifications can be affected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

It should be noted that use of the device with the alternate left eye as the digital eye is also possible, with corresponding changes to description as described and illustrated herein.

Those skilled in the art will appreciate that numerous modifications and variations may be made to the above disclosed embodiments without departing from the spirit and scope of the present invention.

What is claimed is:

1. A display apparatus comprising:
optics that are configured to collimate image-bearing light from a light source along a display apparatus axis towards a first eye of a viewer;
an enclosure configured for positioning the optics at a medial aspect of a first eye of a viewer, adjacent to the nose of a viewer with an ocular disposed within 16 mm of the surface of the first eye and oriented so that the image-bearing light is directed to the first eye of the viewer when the viewer's gaze is directed toward the display apparatus;
wherein the display apparatus axis is positioned to align with a line of sight of the viewer deviated from forward gaze toward a field of view and wherein the display apparatus enclosure is further configured to allow rotation about a vertical y axis, rotation about a horizontal x axis that is orthogonal to the y axis and translation along a z axis that extends outward toward a field of view and is orthogonal to both the x and y axes;
wherein the enclosure is further configured to lie within a portion of the visual field that is visible to the viewer in binocular vision;
wherein the display apparatus is configured to lie outside of the normal line of sight for forward gaze of the viewer, within and/or adjacent to a nasal blind spot, encroaching on a peripheral and an intermediate visual field of the first eye, but not encroaching upon a region of high acuity vision of the viewer; and further configured to lie outside the visual field of the contralateral second eye.

2. The display apparatus of claim 1 where the display apparatus is further configured so that on forward gaze of the viewer, it encroaches upon a central visual field of the viewer but not upon a macular visual field, and wherein the display apparatus is configured to be positioned greater than 9 degrees from a visual midline.

3. The display apparatus of claim 1 where the display apparatus is further configured so than on forward gaze of the viewer, it does not encroach upon a central visual field of the viewer and wherein the display apparatus is configured to be positioned greater than 30 degrees from a visual midline.

4. The display apparatus of claim 1 wherein the light source is an OLED, LED, micro-OLED, or micro-LED flat panel display.

5. The display apparatus of claim 1 wherein the light source is a liquid crystal display.

6. The display apparatus of claim 1 wherein the light source is a raster scanning device.

7. The display apparatus of claim 1 wherein the optics comprise a pancake lens that employs light refraction, polarization, and reflection.

8. The display apparatus of claim 7 further comprising a diffuser for beam expansion.

9. The display apparatus of claim 1 configured to obtain an eye relief distance from the ocular to a surface of the eye of 10 mm or less.

10. The display apparatus of claim 1 wherein movement of the optics provides focusing accommodation.

11. The display apparatus of claim 1 further comprising a head band support for the enclosure.

12. The display apparatus of claim 11 further comprising a nose piece that is coupled to the head band.

13. The display apparatus of claim 1 configured to render a display image in portrait orientation.

14. The display apparatus of claim 1 wherein non-image forming components visible to the viewer encompass no more than 10% of the visual field.

15. The display apparatus of claim 1 where image characteristics of the image-bearing light are altered by modification in light intensity, wavelength, or duration.

16. The display apparatus of claim 1 further comprising a camera or sensor configured to detect the direction of viewer gaze and control logic configured to energize or de-energize the display apparatus according to gaze detection.

17. The display apparatus of claim 1 wherein a camera or sensor positioned at the front of the display, oriented toward the viewer's field of view detects signals to be displayed to the user and is aimed along a camera axis that is colinear with the image produced by the display apparatus.

18. The display apparatus of claim 17 further configured to match the field of view of the image obtained by the camera or sensor to the size of a field of view of the first eye that is obscured by the display apparatus.

19. The display apparatus of claim 17 further configured to spatially co-register an image obtained by the camera or sensor with digital content from a processor and to render a composite display to the first eye of the viewer.

20. A display apparatus configured to emit image-bearing light, comprising;
optics configured to collimate image bearing light from a light source along a display apparatus axis towards a first eye of a viewer;
an enclosure configured for positioning the optics at a medial aspect of a first eye of a viewer, adjacent to the nose of a viewer with an ocular disposed within 16 mm of the surface of the first eye and oriented so that the image-bearing light is directed to the first eye of the viewer when the viewer's gaze is directed toward the display apparatus;
wherein the display apparatus axis is positioned to align with a line of sight of the viewer deviated from forward gaze toward a field of view and wherein the display apparatus enclosure is further configured to allow rotation about a vertical y axis, rotation about a horizontal x axis that is orthogonal to the y axis and translation along a z axis that extends outward toward a field of view and is orthogonal to both the x and y axes;
wherein the enclosure is further configured to lie within a portion of a visual field that is visible to the viewer in binocular vision;
wherein the enclosure does not extend more than 25 mm from the surface of the eye;
wherein the display apparatus is configured to lie outside of the normal line of sight for forward gaze of the viewer, within and/or adjacent to a nasal blind spot, encroaching on a peripheral and an intermediate visual field of the first eye, but not encroaching upon a region of high acuity vision of the viewer;
and further configured to lie outside the visual field of the contralateral second eye.

21. The display apparatus of claim 20 where the display apparatus is further configured so that on forward gaze of the viewer, it encroaches upon a central visual field of the viewer but not upon a macular visual field, and wherein the display apparatus is configured to be positioned greater than 9 degrees from a visual midline.

22. The display apparatus of claim 20 where the display apparatus is further configured so than on forward gaze of the viewer, the display apparatus does not encroach upon a central visual field of the viewer and wherein the display apparatus is configured to be positioned greater than 30 degrees from a visual midline.

23. The display apparatus of claim 20 wherein the light source is an OLED, LED, micro-OLED, or micro-LED flat panel display.

24. The display apparatus of claim 20 wherein the light source is a liquid crystal display.

25. The display apparatus of claim 20 wherein the light source is a raster scanning device.

26. The display apparatus of claim 20 wherein the optics employ light refraction, polarization, and reflection.

27. The display apparatus of claim 26 further comprising a diffuser for beam expansion.

28. The display apparatus of claim 20 configured to obtain an eye relief distance from the ocular to a surface of the eye of 10 mm or less.

29. The display apparatus of claim 20 wherein movement of the optics is used for focusing accommodation.

30. The display apparatus of claim 20 further comprising a head band support for the enclosure.

31. The display apparatus of claim 20 further comprising a nose piece that is coupled to the head band.

32. The display apparatus of claim 20 configured to render a display image in portrait orientation.

33. The display apparatus of claim 20 wherein non-image forming components visible to the viewer encompass no more than 10% of the visual field.

34. The display apparatus of claim 20 where image characteristics of the image-bearing light are altered by modification in light intensity, wavelength, or duration.

35. The display apparatus of claim 20 further comprising a camera or sensor configured to detect the direction of viewer gaze and control logic configured to energize or de-energize the display apparatus according to gaze detection.

36. The display apparatus of claim 20 wherein a camera or sensor positioned at the front of the display, oriented toward the viewer's field of view detects signals to be displayed to the user and is aimed along a camera axis that is colinear with the image produced by the display apparatus.

37. The display apparatus of claim 36 further configured to match the field of view of the image obtained by the camera or sensor to the size of a field of view of the first eye that is obscured by the display apparatus.

38. The display apparatus of claim 36 further configured to spatially co-register an image obtained by the camera or sensor with digital content from a processor and to render a composite display to the first eye of the viewer.
